(19) United States
(12) Patent Application Publication
(10) Pub. No.: US 2026/0196944 A1
(43) Pub. Date: Jul. 9, 2026

(54) CONTROLLER FOR MULTILEVEL POWER CONVERSION SYSTEM, AND MULTILEVEL POWER CONVERSION SYSTEM

(71) Applicant: TMEIC CORPORATION, Tokyo (JP)

(72) Inventors: Daisuke KANDA, Tokyo (JP); Issei FUKASAWA, Tokyo (JP); Masakazu OKAYASU, Tokyo (JP)

(73) Assignee: TMEIC CORPORATION, Tokyo (JP)

(21) Appl. No.: 19/128,383

(22) PCT Filed: Nov. 1, 2023
(86) PCT No.: PCT/JP2023/039524

§ 371 Date: May 8, 2025

(51) Int. Cl. H02M 7/483

(52) U.S. Cl. CPC H02M 7/483

(57) ABSTRACT

A controller for a multilevel power conversion system performs processing of generating a modulated wave based on a voltage command value of each phase, processing of generating carrier waves having a predetermined carrier cycle, processing of generating an injection carrier which changes in a predetermined amplitude range and which is a signal having the same carrier cycle as the carrier cycle of the carrier waves and having a phase opposite to a phase of the carrier waves, processing of generating a modulated wave subjected to carrier injection control of superimposing the modulated wave and the injection carrier, and processing of generating a gate signal that controls operation of the plurality of semiconductor switching elements and a plurality of neutral point elements in the multilevel power converter based on a result of comparing the modulated wave subjected to the carrier injection control with a plurality of the carrier waves.

### TECHNICAL FIELD

The present invention relates to a controller for a multilevel power conversion system, and the multilevel power conversion system.

### BACKGROUND ART

In related art, for example, a multilevel power converter including a plurality of DC capacitors which are two or more DC capacitors connected in series on a DC side, and a plurality of semiconductor switching elements connected at a serial connection point of the plurality of DC capacitors is known (for example, see PTL 1). Note that hereinafter, in the present specification, drawings, and the like, a DC connection point of the plurality of DC capacitors will be also referred to as a “DC neutral point”, and the plurality of semiconductor switching elements connected at the DC connection point (DC neutral point) of the plurality of DC capacitors will be also referred to as “neutral point elements”.

### CITATION LIST

### Patent Literature

[PTL 1] JP 2003319662 A

### SUMMARY OF THE INVENTION

### Problems to be Solved by the Invention

FIG. 31 is a diagram illustrating one example of a configuration of a multilevel power converter 130A according to one aspect. FIG. 31 illustrates a configuration of the multilevel power converter 130A corresponding to three phases, employing a three-level neutral point piloted (NPP) scheme, as a configuration example 1 of the multilevel power converter. As illustrated in FIG. 31, in the multilevel power converter 130A, two DC capacitors Cp and Cn are connected in series via a DC neutral point C, and two semiconductor switching elements (neutral point elements) Q2 and Q3 of each of three phases are connected to the DC neutral point C in inverse series. Note that in the example illustrated in FIG. 31, the semiconductor switching elements (neutral point elements) Q2 and Q3 are connected in inverse series while having a common collector side of an insulated gate bipolar transistor (IGBT). However, the configuration is not limited to this, and while not illustrated, the semiconductor switching elements (neutral point elements) Q2 and Q3 may be connected in inverse series while having a common emitter side.

FIG. 32 is a diagram illustrating one example of a configuration of a multilevel power converter 130B according to another aspect. FIG. 32 illustrates a configuration of the multilevel power converter 130B corresponding to three phases, employing a three-level neutral point clamped (NPC) scheme, as a configuration example 2 of the multilevel power converter. As illustrated in FIG. 32, in the multilevel power converter 130B, two DC capacitors Cp and Cn are connected in series via a DC neutral point C, and a neutral point potential of the DC neutral point C is clamped at diodes D5 and D6, According to this configuration, the multilevel power converter 130B sets a plurality of levels of voltages using this DC neutral point C.

FIG. 33 is a diagram illustrating one example of a configuration of a multilevel power converter 130C according to another aspect. FIG. 33 illustrates a configuration of the multilevel power converter 130C corresponding to one phase, employing a five-level NPP scheme, as a configuration example 3 of the multilevel power converter. As illustrated in FIG. 33, in the multilevel power converter 130G, a total of four DC capacitors Cp and Cn are connected in series via three DC neutral points C, and two semiconductor switching elements (neutral point elements) Q2 and Q3 are connected to each DC neutral point C in inverse series. Note that in the example illustrated in FIG. 33, the semiconductor switching elements (neutral point elements) Q22 and Q3 are connected in inverse series while having a common collector side of the IGBT. However, the configuration is not limited to this, and while not illustrated, the semiconductor switching elements (neutral point elements) Q2 and Q3 may be connected in inverse series while having a common emitter side.

FIG. 34 is a diagram illustrating one example of a configuration of a multilevel power converter 130D according to another aspect. An upper part of FIG. 34 illustrates a configuration of the multilevel power converter 130D corresponding to three phases, employing a nine-level modular multilevel converter (MMC) scheme, as a configuration example 4 of the multilevel power converter. As illustrated in the upper part of FIG. 34, in the multilevel power converter 130D, a plurality of chopper cells Cell #1 to Cell #4 that are the same element are connected to constitute an arm. Note that a lower part of FIG. 34 illustrates one example of a chopper cell of a half bridge and one example of a chopper cell of a full bridge. In the multilevel power converter 130D employing the MMC scheme illustrated in the upper part of FIG. 34, for example, either the chopper cell of the half bridge or the chopper cell of the full bridge illustrated in the lower part of FIG. 34 is provided inside the chopper cells Cell #1 to Cell #4.

By the way, in the related art, in the multilevel power converters 130A to 130D as illustrated in FIG. 31 to FIG. 34, for example, a carrier level shift modulation scheme is used. In the multilevel power converters 130A to 130D in which the carrier level shift modulation scheme is used, a harmonic that is an integral multiple of a carrier frequency, and a sideband wave that is a harmonic generated by a relationship between the carrier frequency and a fundamental frequency (modulated wave frequency) occurs in an output voltage of each phase.

For example, a harmonic component in a relatively high frequency band does not become a big problem because energy can be easily attenuated by a filter. On the other hand, in order to attenuate a harmonic component in a relatively low frequency band, a large filter is required, which may introduce increase in size and cost of an apparatus. It is therefore desired in many power conversion systems to reduce a harmonic near a carrier frequency that is a harmonic component in a relatively low frequency band.

Thus, the present disclosure is directed to reducing a harmonic near a carrier frequency that is a harmonic component in a relatively low frequency band compared to the related art in a multilevel power converter in which a carrier level shift modulation scheme is used.

### Means for Solving the Problems

A controller for a multilevel power conversion system according to one aspect is a controller for a multilevel power conversion system which includes a multilevel power converter including a plurality of semiconductor switching elements and a plurality of neutral point elements and in which a carrier level shift modulation scheme is used, the controller performing processing of generating a modulated wave based on a voltage command value of each phase, processing of generating carrier waves that are triangle wave signals having a predetermined carrier cycle, processing of generating an injection carrier which changes in a predetermined amplitude range and which is a signal having the same carrier cycle as the carrier cycle of the carrier waves and having a phase opposite to a phase of the carrier waves, processing of generating a modulated wave subjected to carrier injection control of superimposing the modulated wave and the injection carrier, and processing of generating a gate signal that controls operation of the plurality of semiconductor switching elements and the plurality of neutral point elements in the multilevel power converter based on a result of comparing the modulated wave subjected to the carrier injection control with a plurality of the carrier waves.

A multilevel power conversion system according to one aspect is a multilevel power conversion system in which a carrier level shift modulation scheme is used, the multilevel power conversion system including a multilevel power converter which includes a plurality of DC capacitors connected in series via a DC neutral point between a positive terminal connected to a DC power supply or a DC load and a negative terminal, a plurality of semiconductor switching elements connected between the positive terminal and the negative terminal, and an AC terminal connected to an AC power supply or an AC load, and a plurality of neutral point elements connected between the DC neutral point and the AC terminal, and a controller that performs processing of generating a modulated wave based on a voltage command value of each phase, processing of generating carrier waves that are triangle wave signals having a predetermined carrier cycle, processing of generating an injection carrier which changes in a predetermined amplitude range and which is a signal having a phase opposite to a phase of the carrier waves and having the same carrier cycle as the carrier cycle of the carrier waves, processing of generating a modulated wave subjected to carrier injection control of superimposing the modulated wave and the injection carrier, and processing of generating a gate signal that controls operation of the plurality of semiconductor switching elements and the plurality of neutral point elements in the multilevel power converter based on a result of comparing the modulated wave subjected to the carrier injection control with a plurality of the carrier waves.

### Advantageous Effects of the Invention

According to the present disclosure, it is possible to reduce a harmonic near a carrier frequency that is a harmonic component in a relatively low frequency band compared to the related art in a multilevel power converter in which a carrier level shift modulation scheme is used.

### BRIEF DESCRIPTION OF THE DRAWINGS

FIG. 1 is a diagram illustrating one example of a configuration of a multilevel power conversion system according to one embodiment.

FIG. 2 is a circuit diagram illustrating one example of a circuit configuration of a multilevel power converter in the multilevel power conversion system illustrated in FIG. 1.

FIG. 3 is a diagram illustrating one example of a configuration of a controller in the multilevel power conversion system illustrated in FIG. 1.

FIG. 4 is a diagram illustrating one example of a control configuration in a voltage command generation unit of a control unit illustrated in FIG. 3.

FIG. 5 is a diagram illustrating one example of a control configuration of a gate signal generation unit of the control unit illustrated in FIG. 3.

FIG. 6 is a diagram illustrating one example of a control configuration of a gate signal generation unit according to a comparative example.

FIG. 7 is a diagram indicating one example of carrier level shift modulation in the gate signal generation unit according to the comparative example illustrated in FIG. 6.

FIG. 8 is a diagram indicating one example of a switching pattern in the carrier level shift modulation.

FIG. 9A, FIG. 9B, FIG. 9C, FIG. 9D and FIG. 9E are diagrams indicating one example of each gate signal of each semiconductor element in the carrier level shift modulation of the switching pattern indicated in FIG. 8.

FIG. 10 is a conceptual diagram of a harmonic spectrum of an output voltage of each phase of a power converter in which the carrier level shift modulation is used.

FIG. 11A, FIG. 11B and FIG. 11C are an enlarged view near a zero crossing point in FIG. 7 and a diagram indicating one example of each gate signal of each semiconductor element at that time.

FIG. 12 is a schematic diagram indicating one example of a relationship among a modulated wave, carrier waves and an output voltage of each phase near a peak of the modulated wave indicated in FIG. 7.

FIG. 13 is a diagram indicating one example of Fourier series expansion of a rectangular wave of the output voltage of each phase indicated in FIG. 12.

FIG. 14 is a diagram indicating one example of a relationship between a sign of the modulated wave and a slope of the modulated wave.

FIG. 15 is a schematic diagram indicating one example of a relationship among a modulated wave, carrier waves and an output voltage of each phase in a pattern 1 indicated in FIG. 14.

FIG. 16 is a schematic diagram indicating one example of a relationship among a modulated wave, carrier waves and an output voltage of each phase in a pattern 2 indicated in FIG. 14.

FIG. 17 is a schematic diagram indicating one example of a relationship among a modulated wave, carrier waves and an output voltage of each phase in a pattern 3 indicated in FIG. 14.

FIG. 18 is a schematic diagram indicating one example of a relationship among a modulated wave, carrier waves and an output voltage of each phase in a pattern 4 indicated in FIG. 14.

FIG. 19 is a diagram indicating one example of a relationship between carrier waves and a modulated wave in a case where carrier injection control is performed in the gate signal generation unit according to one embodiment illustrated in FIG. 5.

FIG. 20A, FIG. 20B and FIG. 20C are an enlarged view near a zero crossing point in FIG. 19 and a diagram indicating one example of each gate signal of each semiconductor element at that time.

FIG. 21 is a schematic diagram indicating one example of a relationship among a modulated wave, carrier waves and an output voltage of each phase in a period during which a slope of the modulated wave is negative.

FIG. 22 is a schematic diagram indicating one example of a relationship among a modulated wave, carrier waves and an output voltage of each phase in a period during which a slope of the modulated wave is positive.

FIG. 23A and FIG. 23B are diagrams indicating one example of a harmonic spectrum of a line output voltage standardized with a DC voltage in a case where carrier injection control is not performed and in a case where carrier injection control is performed.

FIG. 24 is a diagram indicating one example of carrier waves and a modulated wave under a condition where a DC voltage is smaller than an AC output voltage.

FIG. 25A and FIG. 25B are an enlarged view near a peak of the modulated wave in FIG. 24 and a diagram indicating one example of a gate signal at that time.

FIG. 26 is a diagram indicating one example of carrier waves and a modulated wave subjected to carrier injection control under a condition where the DC voltage is smaller than the AC output voltage.

FIG. 27A and FIG. 27B are an enlarged view near a peak of the modulated wave in FIG. 26 and a diagram indicating one example of a gate signal at that time.

FIG. 28A and FIG. 28B are diagrams illustrating one example of charge and discharge of voltages of DC capacitors in a circuit configuration corresponding to one phase, employing a three-level NPP scheme illustrated in FIG. 2.

FIG. 29 is a diagram illustrating one example of a control configuration in a gate signal generation unit according to a modification of one embodiment.

FIG. 30 is a conceptual diagram illustrating a hardware configuration example of a processing circuit of the controller in one embodiment illustrated from FIG. 1 to FIG. 5 and from FIG. 19 to FIG. 29 and a modification thereof.

FIG. 31 is a diagram illustrating one example of a configuration of a multilevel power converter according to one aspect.

FIG. 32 is a diagram illustrating one example of a configuration of a multilevel power converter according to another aspect.

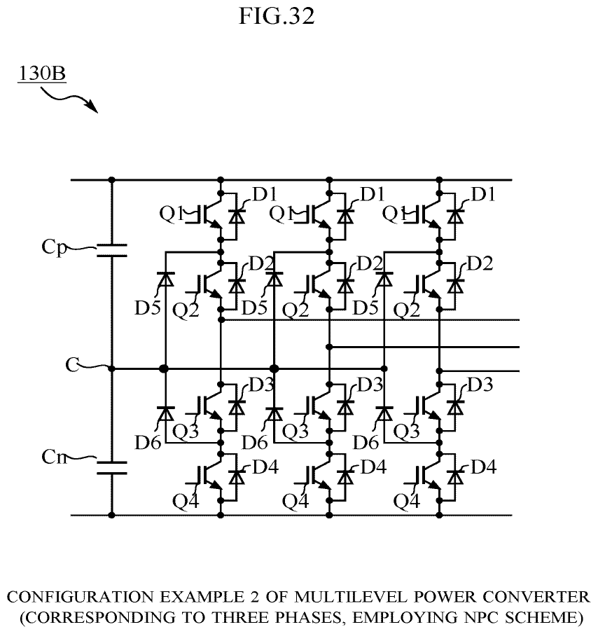

FIG. 33 is a diagram illustrating one example of a configuration of a multilevel power converter according to another aspect.

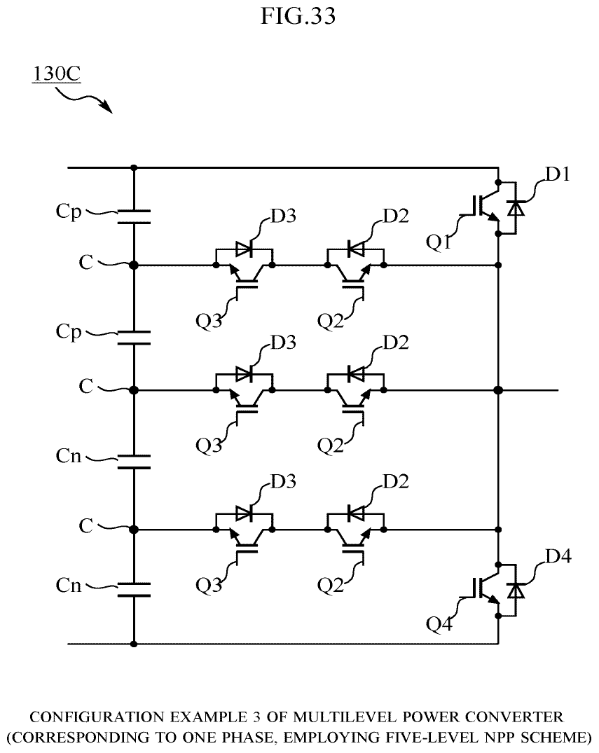

FIG. 34 is a diagram illustrating one example of a configuration of a multilevel power converter according to another aspect.

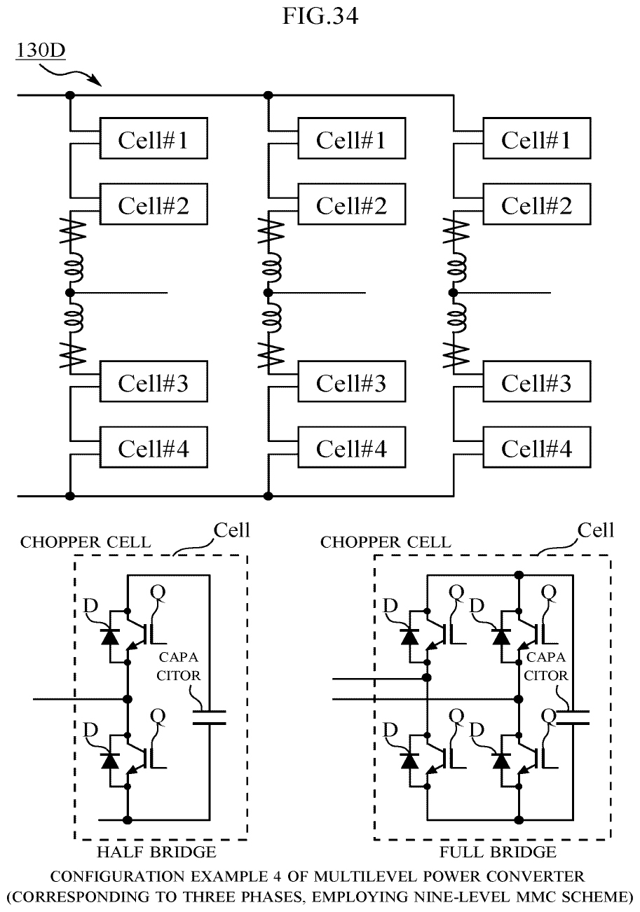

### DESCRIPTION OF EMBODIMENT

An embodiment of a controller for a multilevel power conversion system and the multilevel power conversion system according to the present disclosure will be described below using the drawings.

### Configuration Example of One Embodiment

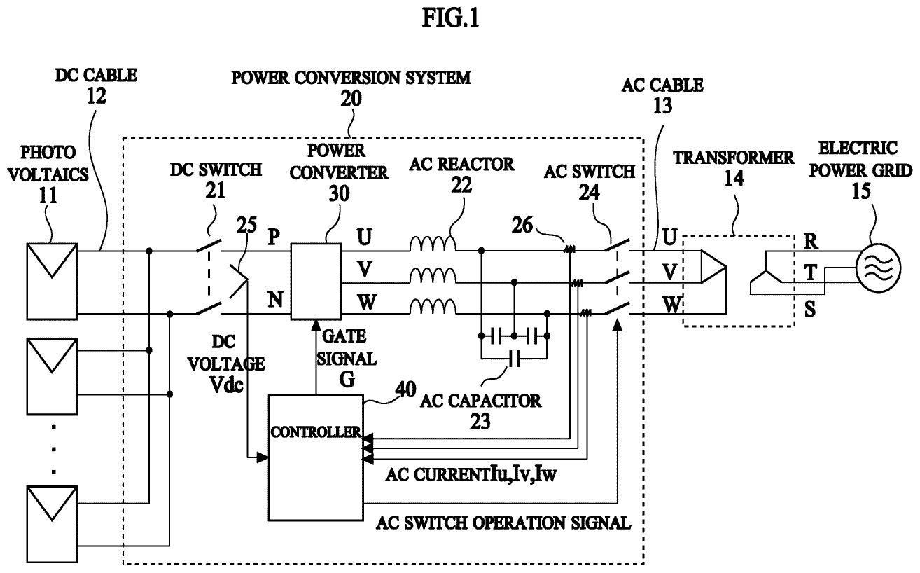

FIG. 1 is a diagram illustrating one example of a configuration of a multilevel power conversion system 20 according to one embodiment.

As illustrated in FIG. 1, the multilevel power conversion system 20 is connected to photovoltaics 11 via a DC cable 12 on a DC side that is a left side in FIG. 1. Further, the multilevel power conversion system 20 is connected to an AC electric power system IS via an AC cable 13 and a transformer 14 on an AC side that is a right side in FIG. 1. The multilevel power conversion system 20, for example, converts DC power acquired from the photovoltaics 11 into AC power and outputs the converted AC power to the AC electric power system 15 via the transformer 14. Hereinafter, in the present specification, drawings, and the like, the multilevel power conversion system 20 will be also referred to as a “power conversion system 20”.

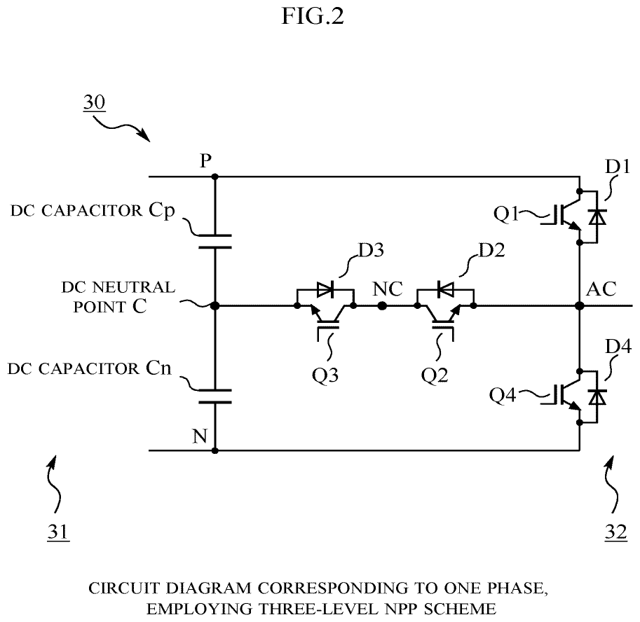

The photovoltaics (PV) 11, which will be also referred to as solar panels, are connected to an input end (a DC input/output unit 31 (see FIG. 2)) that is one end side of the power conversion system 20 via the DC cable 12. The photovoltaics 11 generate power using sunlight, and the generated DC power is supplied to the power conversion system 20 via the DC cable 12. Note that the photovoltaics 11 are one example of a “DC power supply or a DC load”, and may be, for example, a DC power supply such as an “energy storage system (ESS)”, other DC loads, or the like.

The DC cable 12 has one end connected to the photovoltaics 11 and the other end connected to a DC end (the DC input/output unit 31 (see FIG. 2)) of a multilevel power converter 30 which will be described later, of the power conversion system 20. The DC cable 12 includes a positive side cable and a negative side cable and supplies DC power supplied from the photovoltaics 11 to the multilevel power converter 30 which will be described later.

The AC cable 13 has one end connected to an AC end (an AC input/output unit 32 (see FIG. 2)) of the multilevel power converter 30 which will be described later, of the power conversion system 20 and the other end connected to the AC electric power system 15 via the transformer 14. The AC cable 13 is, for example, a three-phase AC circuit employing a three-phase three-wire system that supplies three-phase AC power which is a combination of single-phase alternating currents of three systems obtained by shifting phases of currents or voltages from each other, using three wires, cables and conductors. The AC cable 13 supplies AC power converted by the multilevel power converter 30 which will be described later to the AC electric power system 15 side.

The transformer 14 has one end connected to an output side that is the other end side of the power conversion system 20 via the AC cable 13 and the other end connected to the AC electric power system 15, The transformer 14 transforms a voltage of AC power output from the power conversion system 20 into a predetermined voltage and outputs the power to the AC electric power system 15.

The AC electric power system (electric power system) 15 is a system which is connected to the transformer 14 and supplies the AC power whose voltage is transformed by the transformer 14 to power receiving equipment of a consumer and in which power generation, transformation, transmission and distribution are integrated, and, for example, an unspecified load is connected. Hereinafter, in the present specification, the drawings, and the like, the AC electric power system 15 will be also simply referred to as an “electric power system 15” or a “system 15”. Note that the electric power system 15 is one example of an “AC power supply or an AC load” and may be, for example, a power electric system or, for example, an electric motor, a generator, other AC loads, or the like.

The multilevel power conversion system (power conversion system) 20 is, for example, a power conversion system for photovoltaic generation (photovoltaics). The power conversion system 20 converts DC power supplied from the photovoltaics 11 into AC power and outputs the converted AC power to the electric power system 15 side via the transformer 14. Note that the power conversion system 20 is not limited to a system for photovoltaic generation and may be, for example, a power conversion system for an energy storage system, or the like. Note that hereinafter, in the present specification, the drawings, and the like, the power conversion system 20 will be also referred to as a “power conditioning system (PCS) 20”. Further, the power conversion system for photovoltaic generation will be also referred to as a “photovoltaics-power conditioning system (PV-PCS)”. Still further, the power conversion system for an energy storage system will be also referred to as an “energy storage system-power conditioning system (ESS-PCS)”.

The multilevel power conversion system (power conversion system) 20 includes a DC switch 21, an AC reactor 22, an AC capacitor 23, an AC switch 24, a DC voltage sensor 25, an AC current sensor 26, the multilevel power converter 30, and a controller 40. The DC switch 21 and the DC voltage sensor 25 are positioned between the photovoltaics 11 and the multilevel power converter 30 on the DC cable 12. Further, the AC reactor 22, the AC capacitor 23, the AC switch 24, and the AC current sensor 26 are positioned between the multilevel power converter 30 and the transformer 14 on the AC cable 13. Note that hereinafter, in the present specification, the drawings, and the like, the multilevel power converter 30 will be also referred to as an “n-level power converter 30”, a “power converter 30” or an “inverter 30”.

Note that the multilevel power conversion system 20 may be a system that converts AC power into DC power. In this case, for example, in FIG. 1, the electric power system 15 is an AC power supply that supplies AC power, and an AC load may be connected to the DC cable 12, instead of the photovoltaics 11.

The DC switch (DC breaker) 21 is provided in series between the photovoltaics 11 and the power converter 30 on the DC cable 12. The DC switch 21 is, for example, an electrical contactor, or the like, that can be disconnected and connected in accordance with an instruction from the controller 40. The DC switch 21, for example, switches ON (connects) or OFF (breaks) the DC cable 12 between the photovoltaics 11 and the power converter 30 in accordance with a switching ON instruction or a switching OFF instruction from the controller 40, a host apparatus (not illustrated), or an operator. Note that the DC switch 21 may be, for example, a DC breaker (breaker), or the like, for which disconnecting and connecting operation is normally manually performed and which automatically breaks the DC cable 12 if an overcurrent such as a short-circuit current is detected. If the DC switch 21 is disconnected, inflow of DC power supplied from the photovoltaics 11 into the power converter 30 is broken.

The AC reactor 22 is connected in series to the AC cable 13 of each phase on an output end (the AC input/output unit 32 (see FIG. 2)) of the power converter 30, The AC reactor 22 is, for example, a smoothing element having an effect of reducing noise or an effect of reducing a surge voltage. The AC reactor 22, for example, constitutes an LC filter circuit (filter circuit) that reduces ripple (oscillation) occurring when a semiconductor switching element which will be described later, of the power converter 30 performs switching, along with the AC capacitor 23 connected in an L shape.

The AC capacitor 23 is connected in an L shape to the AC cable 13 of each phase at the output end of the power converter 30 via a branch point. The AC capacitor 23 is an electronic component that stores or discharges electricity (electric charge). The AC capacitor 23, for example, constitutes an LC filter circuit (filter circuit) that reduces ripple (oscillation) occurring when the semiconductor switching element which will be described later, of the power converter 30 performs switching, along with the AC reactor 22 connected in an L shape. The AC capacitor 23 prevents a harmonic (harmonic current) from flowing out to the electric power system 15 side by constituting the filter circuit along with the AC reactor 22.

The AC switch (AC breaker) 24 is provided in series between the AC reactor 22 (filter circuit) and the transformer 14 on the AC cable 13 of each phase. The AC switch 24, for example, switches ON (connects) or OFF (breaks) the AC cable 13 between the power converter 30 and the electric power system 15 in accordance with an AC switch operation signal from the controller 40 or a switching ON instruction or a switching OFF instruction from a host apparatus (not illustrated) or an operator. If the AC switch 24 is disconnected, outflow of AC power supplied from the power converter 30 to the electric power system 15 side is broken.

The DC voltage sensor 25, which is, for example, a publicly known DC voltmeter, a DC voltage sensor, or the like, is provided between the photovoltaics 11 and the power converter 30 and detects a DC voltage value Vdc. Note that a position at which the DC voltage sensor 25 is provided is not limited to the position illustrated in FIG. 1 and may be any position if the DC voltage value Vdc can be detected. Hereinafter, in the present specification, the drawings, and the like, the DC voltage value Vdc will be also referred to as a “DC voltage Vdc”, a “voltage measurement value Vdc” or simply a “voltage Vdc”. The DC voltage Vdc detected by the DC voltage sensor 25 is acquired by the controller 40.

The AC current sensor 26, which is, for example, a publicly known AC ammeter, an AC current sensor, or the like, is provided between the power converter 30 and the transformer 14 and detects AC current values Iu, Iv and Iw of three phases. Note that the position at which the AC current sensor 26 is provided is not limited to the position illustrated in FIG. 1 and may be any position if the AC current values Iu, Iv and Iw of three phases can be detected. Hereinafter, in the present specification, the drawings, and the like, the AC current values Iu, Iv and Iw will be also referred to as “AC currents Iu, Iv and Iw”, “current measurement values Iu, Iv and Iw” or simply “currents Iu, Iv and Iw”. The AC currents Iu, Iv and Iw detected by the AC current sensor 26 are acquired by the controller 40.

The multilevel power converter (power converter) 30 has one end side that is a DC end (the DC input/output unit 31 (see FIG. 2)) connected to the DC switch 21 via the DC cable 12. Further, the power converter 30 has the other end side that is an AC end (the AC input/output unit 32 (see FIG. 2)) connected to the AC reactor 22 (filter circuit) via the AC cable 13, The power converter 30 is, for example, constituted of a plurality of semiconductor switching elements (switching elements) such as an IGBT. The power converter 30 is, for example, controlled by a pulse width modulation (PWM) signal that is a gate drive signal (gate signal G) of the switching element generated at the controller 40. In other words, the power converter 30 is controlled by the gate signal G for causing the power converter 30 to operate.

The power converter 30 acquires DC power supplied from the photovoltaics 11 from one end side that is an input end, converts the acquired DC power into AC power in accordance with control by the pulse width modulation signal (gate signal G) and outputs the AC power from the other end that is an output end to supply to the AC cable 13. In other words, the power converter 30 is caused to operate in accordance with control by the gate signal G. Note that the power converter 30 may convert AC power into DC power, Details of the power converter 30 will be described later (see FIG. 2, and the like).

The controller 40 is, for example, provided inside or outside the power conversion system 20 and is electrically connected to respective components of the power conversion system 20 including the power converter 30 in a wired or wireless manner while part of wirings, and the like, is omitted in the drawings. Note that the controller 40 may be implemented as a function of an inverter control circuit (not illustrated). Further, the controller 40 may operate in accordance with an instruction from a host apparatus (not illustrated) or an instruction from an operator (not illustrated), or the like, via an operation unit (not illustrated). Note that the host apparatus (not illustrated), for example, comprehensively monitors and controls a plurality of power conversion systems 20 and may be connected to each of the power conversion systems 20 in a wired or wireless manner.

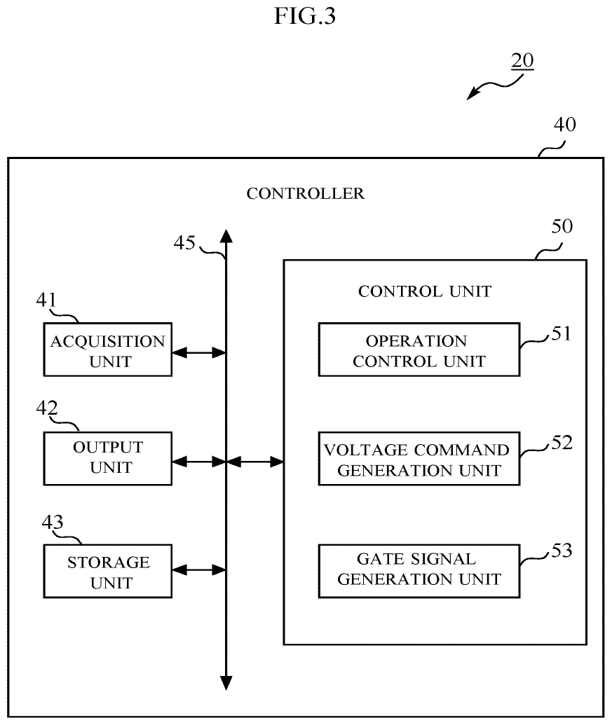

FIG. 2 is a circuit diagram illustrating one example of a circuit configuration of the multilevel power converter 30 in the multilevel power conversion system 20 illustrated in FIG. 1. FIG. 3 illustrates a circuit configuration (circuit diagram) corresponding to one phase (for example, a U phase), employing a three-level NPP scheme as one example of the circuit configuration of the multilevel power converter 30 to simplify the description.

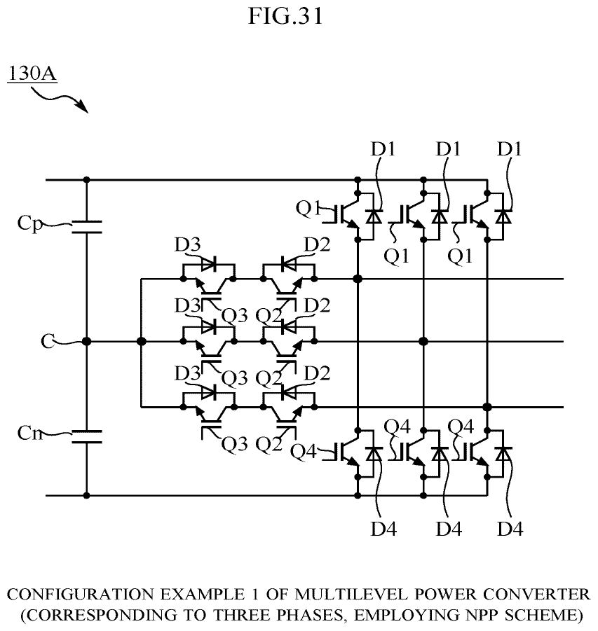

Note that actually, the multilevel power converter 30 has a circuit configuration corresponding to three phases (see, for example, FIG. 31, and the like) in which, for example, three circuits illustrated on the AC side in FIG. 2 are arranged and circuits on the DC side are connected in parallel. However, in the present disclosure, the number of phases in the circuit configuration of the multilevel power converter 30 is not limited to three and may be a single phase or a plurality of phases other than three phases.

Note that in the following description, the three-level power converter 30 will be described as one example of the multilevel power converter 30. However, in the present disclosure, the multilevel power converter 30 is not limited to the three-level power converter 30 and may be an n-level power converter 30 other than the three-level power converter.

Ås illustrated in FIG. 2, the power converter 30 includes the DC input/output unit 31 and the AC input/output unit 32. Further, the power converter 30 includes a positive terminal P, a negative terminal N, a DC capacitor Cp, a DC capacitor Cn, and a DC neutral point C. Further, the power converter 30 includes semiconductor switching elements Q1 and Q4, semiconductor switching elements (neutral point elements) Q2 and Q3, an AC terminal AC and a no connection terminal NC. Note that in the present specification, the drawings, and the like, the AC terminal AC will be also referred to as an “alternating current (AC) terminal”, and the no connection terminal NC will be also referred to as a “no connection (NC) terminal”.

The DC input/output unit 31 is a DC end of the power converter 30 and includes the positive terminal P and the negative terminal N connected to the photovoltaics 11 (a DC power supply or a DC load).

The AC input/output unit 32 is an AC end of the power converter 30 and includes the AC terminal AC connected to the electric power system 15 (an AC power supply or an AC load).

The positive terminal P and the negative terminal N are respectively connected to a positive electrode (P electrode) side and a negative electrode (N electrode) side of the photovoltaics (DC power supply) 11 via the DC cable 12.

The DC capacitor Cp and the DC capacitor On are connected in series between the positive terminal P and the negative terminal N via the DC neutral point C. Further, the semiconductor switching element Q1 and the semiconductor switching element Q4 are connected in series to have the same polarity between the positive terminal P and the negative terminal N via the AC terminal AC (AC terminal).

The semiconductor switching element (neutral point element) Q3 and the semiconductor switching element (neutral point element) Q2 are connected in series to have reverse polarity between the DC neutral point C and the AC terminal AC via the no connection terminal NC (NC terminal).

The semiconductor switching elements Q1 to Q4 respectively have freewheeling diodes D1 to D4, and the semiconductor switching elements Q1 to Q4 and the freewheeling diodes D1 to D4 are respectively connected in inverse parallel. The semiconductor switching elements Q1 to Q4 are, for example, semiconductor switching elements constituted of IGBTs, or the like, and operation of ON/OFF (conduction/non-conduction) is controlled by the gate signal G (see FIG. 1, and the like) output from the controller 40.

Note that hereinafter, in the present specification, the drawings, and the like, the semiconductor switching elements Q1 and Q4 will be also respectively referred to as “semiconductor elements Q1 and Q4” or simply “elements Q1 and Q4”, Further, the semiconductor switching elements Q2 and Q3 will be also respectively referred to as “neutral point elements Q2 and Q3”, “semiconductor elements Q2 and Q3” or simply “elements Q2 and Q3”.

The freewheeling diodes D1 to D4 are freewheeling diodes which are respectively connected to the semiconductor switching elements Q1 to Q4 in inverse parallel and which, for example, reflux energy when the IGBT is OFF (non-conduction). Note that hereinafter, in the present specification, the drawings, and the like, the freewheeling diodes D1 to D4 will be also respectively referred to as “inverse parallel diodes D1 to D4” or simply “diodes D1 to D4”,

FIG. 3 is a diagram illustrating one example of a configuration of the controller 40 in the multilevel power conversion system 20 illustrated in FIG. 1.

The controller 40 acquires the DC voltage Vdc detected by the DC voltage sensor 25 and the AC currents Iu, Iv and Iw detected by the AC current sensor 26 and outputs the gate signal G (see FIG. 1, and the like) in accordance with a control method which will be described later. The controller 40 includes an acquisition unit 41, an output unit 42, a storage unit 43, a system bus 45, and a control unit 50. The acquisition unit 41, the output unit 42, the storage unit 43, and the control unit 50 are connected to each other via a system bus 45.

The acquisition unit 41 is connected to the DC voltage sensor 25, the AC current sensor 26 and the system bus 45. The acquisition unit 41 may be connected to a host apparatus (not illustrated), and the like. The acquisition unit 41, for example, acquires the DC voltage Vdc detected by the DC voltage sensor 25 and the AC currents Iu, Iv and Iw detected by the AC current sensor 26. The acquisition unit 41, for example, outputs the acquired each voltage value and each current value to each component of the controller 40 via the system bus 45.

The output unit 42 is connected to the AC switch 24, the power converter 30, and the system bus 45. The output unit 42 may be connected to a host apparatus (not illustrated), and the like. The output unit 42, for example, outputs the gate signal G to the power converter 30 in accordance with the instruction acquired from the control unit 50 via the system bus 45.

The storage unit 43, which is, for example, a volatile or a non-volatile storage medium such as a hard disk drive (HDD), a solid state drive (SSD), and other semiconductor memories, is connected to the system bus 45, The storage unit 43, for example, stores programs necessary for operation of the respective units of the controller 40, and various kinds of information are written in or read out from the storage unit 43 by the respective units of the controller 40. Further, the storage unit 43 stores, for example, values detected by respective sensors such as the DC voltage sensor 25 and the AC current sensor 26, an instruction provided from a host apparatus (not illustrated), an operator, or the like, various kinds of arithmetic expressions and coefficients to be used in calculation by the control unit 50, predetermined thresholds, determination values, and the like.

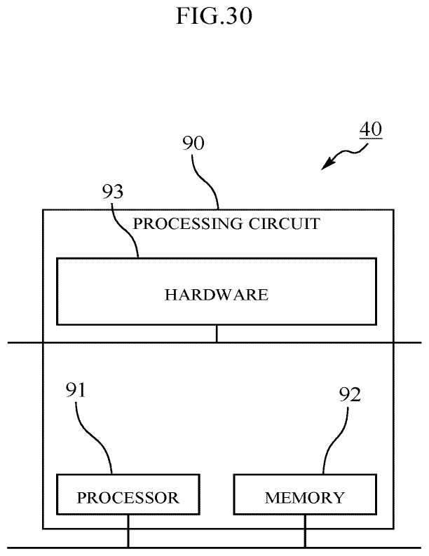

The storage unit 43 is connected to the respective units of the controller 40 by the system bus 45, or the like, so that various kinds of information can be input/output. Note that the storage unit 43 may be provided outside the controller 40 and may be connected to the controller 40 in a wired or wireless manner. Further, the storage unit 43 may be an external storage medium, or the like, such as a memory card and a digital versatile disc (DVD), or may be an online storage, or the like. Further, the storage unit 43 may be also used as a memory 92 (see FIG. 30) which will be described later.

The system bus (bus) 45, which is a data transmission path (bus) connecting respective components inside the controller 40, connects the acquisition unit 41, the output unit 42, the storage unit 43 and the control unit 50 so that various kinds of information can be input/output.

The control unit 50 includes, for example, a processor 91 (see FIG. 30) which will be described later such as a central processing unit (CPU) that operates by executing a program. The control unit 50, for example, comprehensively controls operation of the power conversion system 20 by causing the processor 91 to operate by executing a predetermined program stored in the storage unit 43 or a memory 92 (see FIG. 30) which will be described later. Note that the control unit 50 may control the operation of the power conversion system 20 in accordance with an instruction accepted from a host apparatus (not illustrated) or an instruction accepted from an operator (not illustrated) via an operation unit (not illustrated).

The control unit 50, for example, functions as the following respective units by executing a predetermined program stored in the storage unit 43 or the memory 92 (see FIG. 30) which will be described later. The control unit 50, for example, functions as an operation control unit 51, a voltage command generation unit 52, and a gate signal generation unit 53. Note that the above-described respective functions may be implemented by a program to be executed by a processor 91 (see FIG. 30) which will be described later in a processing circuit 90 (see FIG. 30) which will be described later, of the controller 40 or may be implemented by hardware 93 (see FIG. 30) which will be described later. Note that the operation control unit 51, the voltage command generation unit 52, and the gate signal generation unit 53 perform the following processing by executing the predetermined program.

The operation control unit 51, for example, comprehensively controls operation of the respective units of the power conversion system 20 in addition to outputting the AC switch operation signal (see FIG. 1, and the like) to the AC switch 24 based on a predetermined condition.

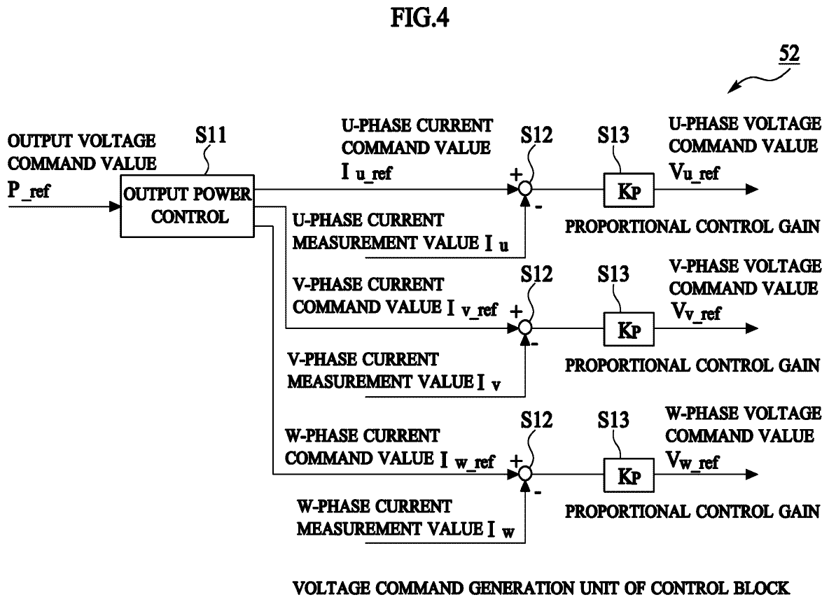

The voltage command generation unit 52, for example, generates voltage command values Vu_ref, Vv_ref and Vw_ref of three phases based on a predetermined output voltage command value P ref and AC currents Iu, lv and Iw of three phases detected by the AC current sensor 26. Then, the voltage command generation unit 52 outputs the generated voltage command values Vu_ref, Vv_ref and Vw_ref of three phases to the gate signal generation unit 53. Note that details of a control configuration or processing (operation) of the voltage command generation unit 52 in the control unit 50 (control block) will be described later (see FIG. 4, and the like).

The gate signal generation unit 53 acquires the voltage command values Vu_ref, Vv_ref and Vw_ref output from the voltage command generation unit 52 and the DC voltage Vde detected by the DC voltage sensor 25. Further, the gate signal generation unit 53 acquires triangle wave carriers (carrier waves) CA1 and CA2 having a predetermined carrier cycle and an injection carrier CAin for predetermined carrier injection control. Note that in the present specification, the drawings, and the like, the injection carrier CAin is a triangle wave signal having a phase opposite to the phase of the triangle wave carriers (carrier waves) CA1 and CA2, and the carrier injection control is control of superimposing (injecting) the injection carrier CAin on modulated waves Du, Dv and Dw.

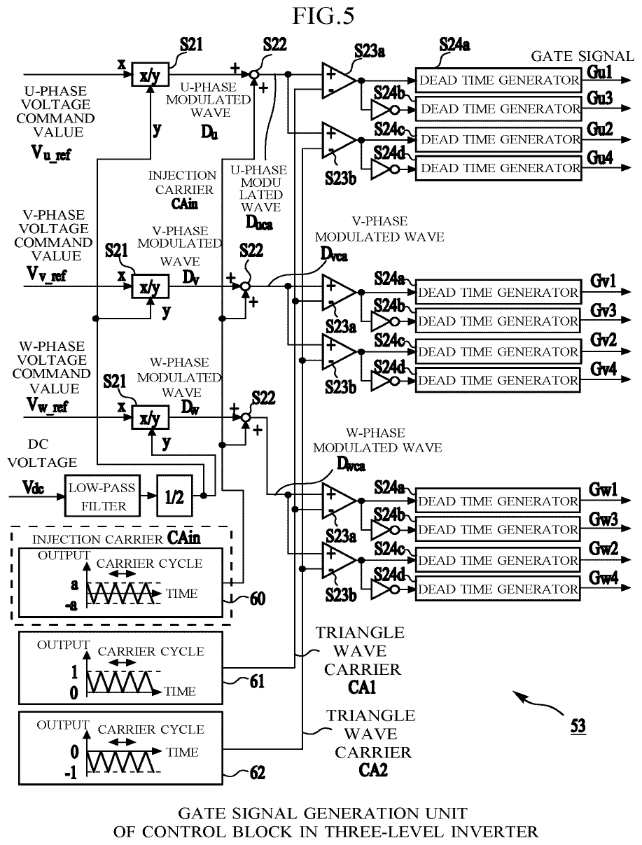

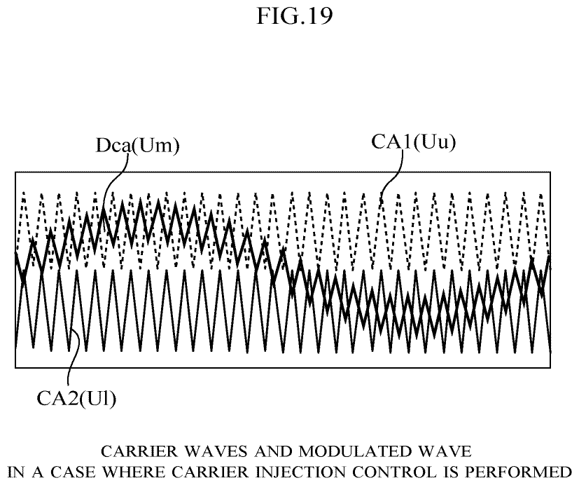

The gate signal generation unit 53, for example, generates the gate signal G (see FIG. 1, and the like) based on the voltage command values Vu_ref, Vv_ref and Vw_ref; the DC voltage Vdc, the triangle wave carriers CA1 and CA2, and the predetermined injection carrier CAin. The gate signal generation unit 53 outputs the generated gate signal G to the power converter 30 and controls operation of ON/OFF (conduction/non-conduction) of the semiconductor switching elements Q1 to Q4 (see FIG. 2, and the like). Note that details of a control configuration or processing (operation) of the gate signal generation unit 53 in the control unit 50 (control block) will be described later (see FIG. 5, FIGS. 19 to 22, and the like).

### Control Configuration Example of One Embodiment

FIG. 4 is a diagram illustrating one example of a control configuration in the voltage command generation unit 52 of the control unit 50 illustrated in FIG. 3. While FIG. 4 illustrates a control configuration example of three phases of a U phase, a V phase and a W phase, in the following description, control of the U phase will be described as an example for control common among the respective phases.

In step S11, the voltage command generation unit 52 acquires a predetermined output power command value P_ref and outputs a U-phase current command value Iu_ref based on the acquired output power command value P ref. Note that the predetermined output power command value P ref is, for example, acquired based on predetermined calculation results, and the like, based on maximization of a power generation amount from the photovoltaics 11, predetermined power supply, power demand, and the like, or acquired from the storage unit 43, a host apparatus (not illustrated), or the like.

In step S12, the voltage command generation unit 52 acquires the U-phase current command value Iu_ref output through the processing in step S11. Further, the voltage command generation unit 52 acquires the U-phase AC current Iu (U-phase current measurement value Iu) detected by the AC current sensor 26 (see FIG. 1), for example, via the acquisition unit 41 (see FIG. 3). Then, the voltage command generation unit 52 subtracts the acquired U-phase current measurement value Iu from the acquired U-phase current command value Iu_ref and outputs a value after the subtraction.

In step S13, the voltage command generation unit 52 performs proportional control based on the value output through the processing in step S12 and a proportional control gain Kp and outputs the U-phase voltage command value Vu_ref obtained through the proportional control to the gate signal generation unit 53 (see FIG. 3, FIG. 5, and the like).

Note that the voltage command generation unit 52 obtains the V-phase voltage command value Vv_ref and the W-phase voltage command value Vw_ref in step S11 to S13 in a similar manner to the U phase and outputs the obtained V-phase voltage command value Vv_ref and W-phase voltage command value Vw_ref to the gate signal generation unit 53.

Note that the processing to be performed in the voltage command generation unit 52 described in FIG. 4 is similar to processing to be typically performed in control of a normal power converter.

FIG. 5 is a diagram illustrating one example of a control configuration in the gate signal generation unit 53 of the control unit 50 illustrated in FIG. 3. While FIG. 5 illustrates a control configuration example of three phases of the U phase, the V phase and the W phase, in the following description, control of the U phase will be described as an example for control common among the respective phases.

In step S21, the gate signal generation unit 53 acquires the U-phase voltage command value Vu_ref (x) output from the voltage command generation unit 52 (see FIG. 3, FIG. 4, and the like), Further, the gate signal generation unit 53 acquires a value (y) that is the DC voltage Vdc halved by applying a low-pass filter to the DC voltage Vdc detected by the DC voltage sensor 25. The gate signal generation unit 53 divides the acquired value (x) by the acquired value (y) by a divider (x/y) to obtain the U-phase modulated wave Du and outputs the obtained U-phase modulated wave Du. Note that the modulated wave D is, for example, a voltage command value normalized by a half of the DC voltage, and in this case, is obtained by dividing the voltage command value V ref by a value that is the DC voltage Vdc halved by applying the low-pass filter to the DC voltage Vde.

In step S22, the gate signal generation unit 53 acquires the U-phase modulated wave Du output through the processing in step S21 and the injection carrier CAin generated by the injection carrier generator 60. The gate signal generation unit $3 adds the acquired U-phase modulated wave Du and the acquired injection carrier CAin by an adder and performs carrier injection control of superimposing the U-phase modulated wave Du on the injection carrier CAin to generate the U-phase modulated wave Duca subjected to carrier injection control. The gate signal generation unit 53 outputs the generated U-phase modulated wave Duca subjected to carrier injection control.

Here, the injection carrier generator 60 generates the injection carrier CAin which is a triangle wave signal that changes in a range from a to −a in the same carrier cycle as the carrier cycle of the carrier generators 61 and 62 that generate the triangle wave carriers (carrier waves) CA1 and CA2. The injection carrier CAin is a triangle wave signal having a phase opposite to the phase of the triangle wave carriers (carrier waves) CA1 and CA2. The injection carrier generator 60 is, for example, added to the gate signal generation unit $3 in a software manner. Note that the “range from a to −a” is one example of a “predetermined amplitude range”.

Note that a value of a may be, for example, either a value obtained through calculation, experiment, simulation, or the like, based on power demand, power supply, or the like, or a value instructed from a host apparatus (not illustrated), an operator, or the like. Note that the value of a is at least a value from 0 to 1, and, for example, from 0.2 to 0.3 (20 to 30% of the amplitude of the carrier waves CA1 and CA2), or the like. In other words, the injection carrier CAin generated at the injection carrier generator 60 is, for example, a triangle wave signal which changes in a range from 0.2 to 0.3 (a) or from −0.2 to −0.3 (−a) (predetermined amplitude range), which has the same carrier cycle as the carrier cycle of the carrier waves CA1 and CA2 and which has a phase opposite to the phase of the carrier waves CA1 and CA2.

Note that the value of a may be made to dynamically fluctuate in accordance with a situation of the DC voltage, a modulation factor, or the like, instead of a fixed value. For example, in a case where the DC voltage is low, a capacitor current may become larger by increasing the value of a, and in a case where the DC voltage is high, the capacitor current may become smaller by increasing the value of a. Thus, to reduce the capacitor current, in a case where the DC voltage is low, the value of a may be made smaller, and in a case where the DC voltage is high, the value of a may be made greater. For example, the gate signal generation unit 53 may make the value of a smaller in a case where the DC voltage Vdc detected by the DC voltage sensor 25 is lower than a predetermined threshold and may make the value of a greater in a case where the DC voltage Vde is higher than the predetermined threshold. In this manner, for example, by dynamically fluctuating the value of a in accordance with the situation of the DC voltage, the modulation factor, or the like, instead of setting the fixed value, it is possible to reduce the capacitor current in accordance with the situation compared to the related art.

In step S23a, the gate signal generation unit 53 compares the U-phase modulated wave Duca subjected to carrier injection control, output through the processing in step S22 with the triangle wave carrier CA1 generated by the carrier generator 61 by a comparator. Then, the gate signal generation unit 53 outputs a signal of 1 in a case where the U-phase modulated wave Duca subjected to carrier injection control is greater than the triangle wave carrier CA1, and outputs a signal of 0 in a case where the U-phase modulated wave Duca is smaller than the triangle wave carrier CA1. Note that the triangle wave carrier CA1 is a triangle wave signal that changes from 0 to 1 in a certain carrier cycle, that is, an upper carrier wave. Hereinafter, in the present specification, the drawings, and the like, the triangle wave carrier CA1 will be also referred to as an “upper carrier wave CA1” or simply a “carrier wave CA1”.

In step S23b, the gate signal generation unit 53 compares the U-phase modulated wave Duca subjected to carrier injection control, output through the processing in step S22 with the triangle wave carrier CA2 generated by the carrier generator 62 by the comparator. Then, the gate signal generation unit 53 outputs a signal of 1 in a case where the U-phase modulated wave Duca subjected to carrier injection control is greater than the triangle wave carrier CA2, and outputs a signal of 0 in a case where the U-phase modulated wave Duca is smaller than the triangle wave carrier CA2. Note that the triangle wave carrier CA2 is a triangle wave signal that changes from −1 to 0 in a certain carrier cycle, that is, a lower carrier wave. Hereinafter, in the present specification, the drawings, and the like, the triangle wave carrier CA2 will be also referred to as a “lower carrier wave CA2” or simply a “carrier wave CA2”.

In step S24a, the gate signal generation unit 53 generates a signal obtained by delaying a value of the signal output through the processing in step S23a by a dead time generator and outputs the value as a gate signal Gu1. Here, the gate signal Gu1 is a gate signal G1 that controls switching operation of the U-phase semiconductor switching element Q1 (see FIG. 2, and the like). Note that the dead time generator prevents short-circuit by simultaneous conduction of the semiconductor switching elements Q1 to Q4 and outputs a signal for which a rise time point of the pulse command value is delayed.

In step S24b, the gate signal generation unit 53 generates a signal for which a value of a negative logic (NOT) of the signal output through the processing in step S23a is delayed by the dead time generator and outputs the signal as a gate signal Gu3. In other words, the gate signal generation unit 53 generates a signal delayed by 1 in a case where the signal output in step S23a is 0 and delayed by 0 in a case where the signal is 1 by the dead time generator and outputs the signal as the gate signal Gu3. Here, the gate signal Gu3 is the gate signal G3 that controls switching operation of the U-phase semiconductor switching element (neutral point element) Q3 (see FIG. 2, and the like).

In step S24c, the gate signal generation unit 53 generates a signal obtained by delaying the signal output through the processing in step S23b by the dead time generator and outputs the signal as a gate signal Gu2. Here, the gate signal Gu2 is the gate signal G2 that controls switching operation of the U-phase semiconductor switching element (neutral point element) Q2 (see FIG. 2, and the like).

In step S24d, the gate signal generation unit 53 generates a signal obtained by delaying a value of a negative logic (NOT) of the signal output through the processing in step S23b by the dead time generator and outputs the signal as a gate signal Gu4. In other words, the gate signal generation unit 53 generates a signal delayed by 1 in a case where the signal output in step S23b is 0 and delayed by 0 in a case where the signal is 1 by the dead time generator and outputs the signal as the gate signal Gu4. Here, the gate signal Gu4 is the gate signal G4 that controls switching operation of the U-phase semiconductor switching element Q4 (see FIG. 2, and the like).

Note that the gate signal generation unit 53 performs processing indicated in the above step S21 to S24d also for the V phase and the W phase in a similar manner to the U phase. In other words, the gate signal generation unit 53 generates and outputs the gate signals Gv1 to Gv4 and Gw1 to Gw4 (G1 to G4) that control operation of the semiconductor switching elements Q1 to Q4 of the V phase and the W phase in a similar manner to the U phase.

As described above, according to the control configuration example of one embodiment illustrated in FIG. 1 to FIG. 5, control different from control of the three-level (multilevel) power converter in which a normal carrier level shift modulation scheme is used is included. In other words, normally, control of inputting a result of comparing the modulated wave D obtained by normalizing the voltage command value V_ref of each phase with the triangle wave carriers CA1 and CA2 to the dead time generator and then generating and outputting the gate signals G1 to G4 Is performed.

On the other hand, in one embodiment illustrated in FIG. 1 to FIG. 5, the gate signal generation unit 53 acquires the modulated wave D obtained by normalizing the voltage command value V ref of each phase and the injection carrier CAin generated by the injection carrier generator 60. Note that the injection carrier CAin is a triangle wave signal which changes in a range from a to −a (predetermined amplitude range), which has the same carrier cycle as the carrier cycle of the carrier waves CA1 and CA2 and which has a phase opposite to the phase of the carrier waves CA1 and CA2. Then, the gate signal generation unit 53 performs carrier injection control of superimposing the modulated wave D on the injection carrier CAin to generate a modulated wave Dca subjected to carrier injection control. Then, the gate signal generation unit 53 inputs a result of comparing the modulated wave Dca subjected to carrier injection control with the triangle wave carriers CA1 and CA2 to the dead time generator and generates and outputs the gate signals G1 to G4.

In other words, in one embodiment, the gate signal generation unit 53 has a characteristic configuration of the injection carrier generator 60 that generates the injection carrier CAin that is a triangle wave signal which changes from a to −a, which has the same carrier cycle as the carrier cycle of the carrier waves CA1 and CA2 and which has a phase opposite to the phase of the carrier waves CA1 and CA2. Further, the gate signal generation unit 53 generates and outputs the gate signals G1 to G4 based on the modulated wave Dca subjected to carrier injection control of superimposing the modulated wave D on the injection carrier CAin.

### <Generation Principle of Harmonic>

Here, before description of processing (operation) and operational effects of one embodiment illustrated in FIG. 1 to FIG. 5, generation principle of a harmonic will be described using a multilevel power conversion system 120 according to a comparative example in which a normal carrier level shift modulation scheme is used. Note that in a similar manner to one embodiment illustrated in FIG. 1 to FIG. 5, in the following comparative example, description will be provided using a three-level power conversion system 120 as one example of the multilevel power conversion system 120. Note that in the present specification, the drawings, and the like, the multilevel power conversion system 120 and the three-level power conversion system 120 will be also simply referred to as a “power conversion system 120”.

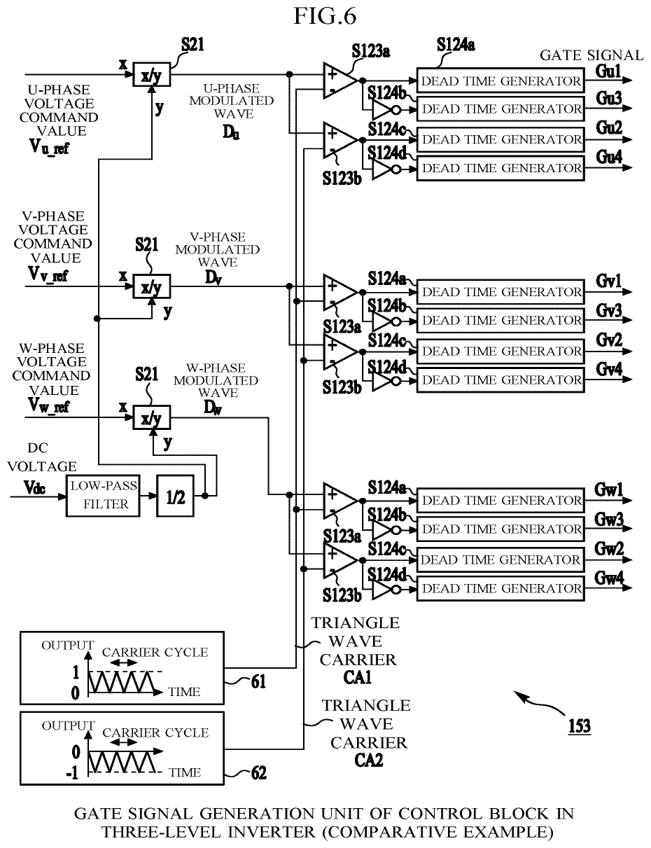

FIG. 6 is a diagram illustrating one example of a control configuration in the gate signal generation unit 153 according to the comparative example. While FIG. 6 illustrates a control configuration example of three phases of the U phase, the V phase and the W phase, in the following description, control of the U phase will be described as an example concerning control common among the respective phases.

Note that in the following comparative example, the gate signal generation unit 53 illustrated in FIG. 3 and FIG. 5 in the power conversion system 20 according to one embodiment illustrated in FIG. 1 to FIG. 5 is replaced with a gate signal generation unit 153. Other components in the power conversion system 120 according to the following comparative example are the same as or similar to the components in the power conversion system 20 according to one embodiment illustrated in FIG. 1 to FIG. 5. Thus, in the following comparative example, components that are the same as or similar to the components of the power conversion system 20 according to one embodiment illustrated in FIG. 1 to FIG. 5 will be denoted by the same reference numerals, and detailed description and illustration will be omitted.

In step S121, processing that is the same as or similar to the processing in step S21 illustrated in FIG. 5 is performed, and thus, description will be omitted. Here, as illustrated in FIG. 6, the gate signal generation unit 153 according to the comparative example does not include the injection carrier generator 60 unlike with the gate signal generation unit 53 according to one embodiment illustrated in FIG. 5. Thus, in the gate signal generation unit 153 according to the comparative example illustrated in FIG. 6, the processing in step S22 in the gate signal generation unit 53 according to one embodiment illustrated in FIG. 5 is not performed.

In step S123a, the gate signal generation unit 153 compares the U-phase modulated wave Du output through the processing in step S121 with the triangle wave carrier (upper carrier wave) CA1 generated by the carrier generator 61 by the comparator. Then, the gate signal generation unit 153 outputs a signal of 1 in a case where the U-phase modulated wave Du is greater than the triangle wave carrier CA1 and outputs a signal of 0 in a case where the U-phase modulated wave Du is smaller than the triangle wave carrier CA1.

In step S123b, the gate signal generation unit 153 compares the U-phase modulated wave Du output through the processing in step S121 with the triangle wave carrier (lower carrier wave) CA2 generated by the carrier generator 62 by the comparator. Then, the gate signal generation unit 153 outputs a signal of 1 in a case where the U-phase modulated wave Du is greater than the triangle wave carrier CA2 and outputs a signal of 0 in a case where the U-phase modulated wave Du is smaller than the triangle wave carrier CA2.

In step S124a, the gate signal generation unit 153 generates a signal obtained by delaying a value of the signal output through the processing in step S123a by the dead time generator and outputs the signal as the gate signal Gu1.

In step S124b, the gate signal generation unit 153 generates a signal obtained by delaying a value of a negative logic (NOT) of the signal output through the processing in step S123a by the dead time generator and outputs the signal as the gate signal Gu3.

In step S124c, the gate signal generation unit 153 generates a signal obtained by delaying the signal output through the processing in step S123b by the dead time generator and outputs the signal as the gate signal Gu2.

In step S124d, the gate signal generation unit 153 generates a signal obtained by delaying a value of a negative logic (NOT) of the signal output through the processing in step S123b by the dead time generator and outputs the signal as the gate signal Gu4.

Note that the gate signal generation unit 153 performs the processing indicated in the above-described step S121 to S124d also for the V phase and the W phase in a similar manner to the U phase and generates and outputs the gate signals Gv1 to Gv4 and Gw1 to Gw4.

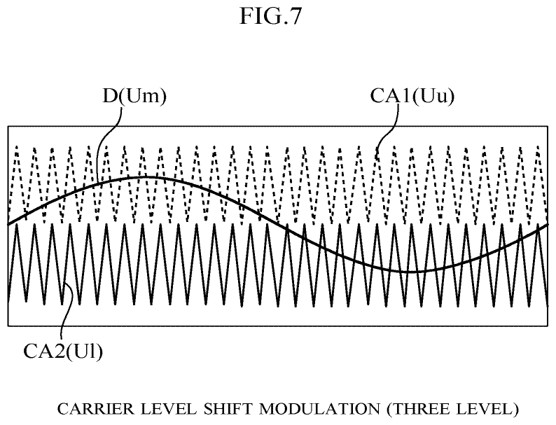

FIG. 7 is a diagram indicating one example of carrier shift modulation in the gate signal generation unit 153 according to the comparative example illustrated in FIG. 6. FIG. 7 indicates a voltage on a vertical axis and indicates time on a horizontal axis, Further, a thick solid line at the center indicates a waveform of the modulated wave D, a dashed line in an upper part indicates a waveform of the upper carrier wave CA1, and a solid line in a lower part indicates a waveform of the lower carrier wave CA2. Note that it is assumed in the following description that the power converter (inverter) 30 in which carrier level shift modulation is performed has a circuit configuration employing a three-level NPP scheme illustrated in FIG. 2.

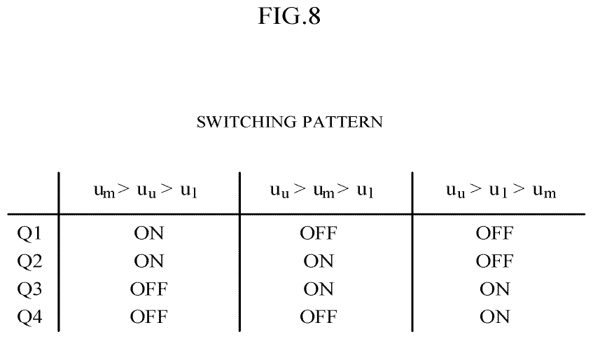

As illustrated in FIG. 7, the carrier level shift modulation scheme is a modulation scheme of generating the gate signals G1 to G4 of the semiconductor elements Q1 to Q4 by comparing the carrier waves CA1 and CA2 on which a DC offset is superimposed with the modulated wave D. In other words, in the carrier level shift modulation, the DC offset is equally superimposed on the respective carrier waves CA1 and CA2, magnitudes of the carrier waves CA1 and CA2 are compared with a magnitude of the modulated wave D, and the gate signal G is generated in accordance with a switching pattern determined in advance which will be described later (see FIG. 8).

FIG. 8 is a diagram indicating one example of the switching pattern in the carrier level shift modulation. In FIG. 8, Uu indicates a voltage of the upper carrier wave CA1 indicated in FIG. 7, Ul indicates a voltage of the lower carrier wave CA2 indicated in FIG. 7, and Um indicates a voltage of the modulated wave D indicated in FIG. 7. Further, in FIGS. 8, Q1 to Q4 respectively indicate semiconductor elements Q1 to Q4 illustrated in FIG. 2, ON/OFF indicates ON/OFF of the gate signals G1 to G4 of the semiconductor elements Q1 to Q4.

As indicated in FIG. 8, for example, in a case where Um>Uu>Ul, the semiconductor element Q1 is ON (conductive), the semiconductor element Q2 is ON (conductive), the semiconductor element Q3 is OFF (non-conductive), and the semiconductor element Q4 is OFF (non-conductive). In a similar manner, for example, in a case where Uu>Um>Ul, the semiconductor element Q1 is OFF (non-conductive), the semiconductor element Q2 is ON (conductive), the semiconductor element Q3 is ON (conductive), and the semiconductor element Q4 is OFF (non-conductive). In a similar manner, for example, in a case where Uu>Ul>Um, the semiconductor element Q1 is OFF (non-conductive), the semiconductor element Q2 is OFF (non-conductive), the semiconductor element Q3 is ON (conductive), and the semiconductor element Q4 is ON (conductive),

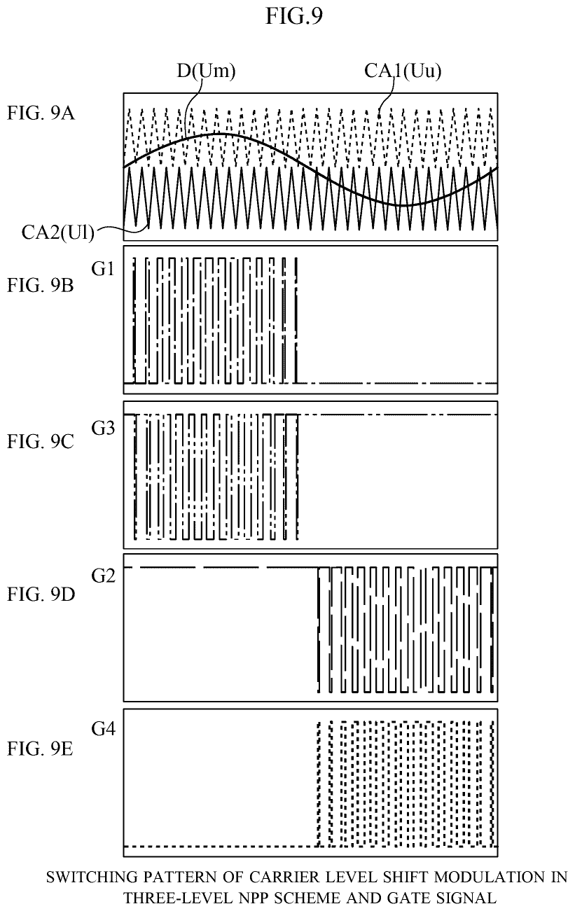

FIG. 9A, FIG. 9B, FIG. 9C, FIG. 9D and FIG. 9E are diagrams indicating one example of the gate signals G1 to G4 of the semiconductor elements Q1 to Q4 in carrier level shift modulation of the switching pattern indicated in FIG. 8. In FIG. 9, FIG. 9A indicates one example of carrier level shift modulation employing the three-level NPP scheme according to the comparative example indicated in FIG. 7, and FIG. 9B to FIG. 9E indicate one example of the gate signals G1 to G4 of the semiconductor elements Q1 to Q4 corresponding to FIG. 9A. In the gate signals G1 to 04 in FIG. 9B to FIG. 9E, in a case where lines of pulses are positioned in an upper part, it indicates that the gate signals G1 to G4 are ON (1), and in a case where the lines of the pulses are positioned in a lower part, it indicates that the gate signals G1 to G4 are OFF (0).

As indicated in FIG. 9, the gate signals G1 to G4 of the semiconductor elements Q1 to Q4 are generated in accordance with the switching pattern determined in advance indicated in FIG. 8. Note that ON (1)/OFF (0) of the gate signals G1 to G4 corresponds to ON (conductive)/OFF (non-conductive) of the semiconductor elements Q1 to Q4.

In other words, as indicated in FIG. 8 and FIG. 9, for example, the gate signal G1 is ON (1) in a case where Um>Uu>Ul, is OFF (0) in a case where Uu>Um>Ul, and is OFF (0) in a case where Uu>Ul>Um. In a similar manner, for example, the gate signal G2 is ON (1) in a case where Um>Uu>Ul, is ON (1) in a case where Uu>Um>Ul, and is OFF (0) in a case where Un>Ul>Um. In a similar manner, for example, the gate signal G3 is OFF (0) in a case where Um>Uu>UL, is ON (1) in a case where Uu>Um>Ul, and is ON (1) in a case where Uu>Ul>Um. In a similar manner, for example, the gate signal G4 is OFF (0) in a case where Um>Uu>Ul, is OFF (0) in a case where Uu>Um>Ul, and is ON (1) in a case where Uu>Ul>Um.

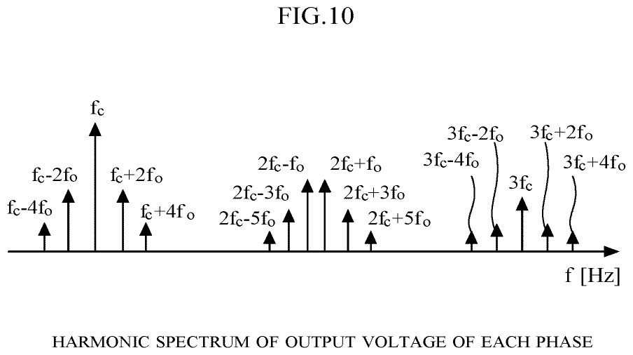

FIG. 10 is a conceptual diagram of a harmonic spectrum of an output voltage of each phase of the power converter 30 in which carrier level shift modulation is used. FIG. 10 indicates a magnitude of a harmonic spectrum on a vertical axis and a frequency on a horizontal axis. Further, fc indicates a carrier frequency, and fo indicates a fundamental frequency (modulated wave frequency).

As indicated in FIG. 10, the output voltage of each phase includes a harmonic that is an integral multiple of the carrier frequency fo, and a harmonic generated by a relationship between the carrier frequency fc that is called a sideband wave, and the fundamental frequency fo. For example, in FIG. 10, the harmonic that is an integral multiple of the carrier frequency fc is, for example, 3fc, or the like. Note that 2fc disappears after calculation (addition) by a plus and minus relationship, and thus, does not appear in FIG. 10. Further, in FIG. 10, the harmonic that is called a sideband wave indicates a frequency component occurring in a high frequency band/low frequency band centering around the carrier frequency fc (or a frequency component that is an integral multiple of the carrier frequency fc) like fc±2fo.

Here, as a filter of the power converter (inverter) 30, a low-pass filter (filter) like an LC filter is used to reduce a harmonic component of the output voltage. A harmonic component in a relatively high frequency band (for example, a right side in FIG. 10) does not become a big problem, because energy can be easily attenuated by the filter. On the other hand, a harmonic component in a relatively low frequency band (for example, a left side in FIG. 10) becomes a problem because a large filter is required to attenuate the harmonic component.

In other words, the low-pass filter can attenuate energy of a signal more as a frequency is higher for a signal equal to or higher than a cutoff frequency. Thus, while it is easy to attenuate a high frequency component with the low-pass filter, it is difficult to attenuate a low frequency component. To attenuate a low frequency component, for example, in a case of an LC filter, while it is only necessary to physically increase a size of the filter to increase L or C, this may lead to increase in size and cost of an apparatus. It is therefore required to reduce a harmonic near the carrier frequency fc that is a harmonic component in a relatively low frequency band.

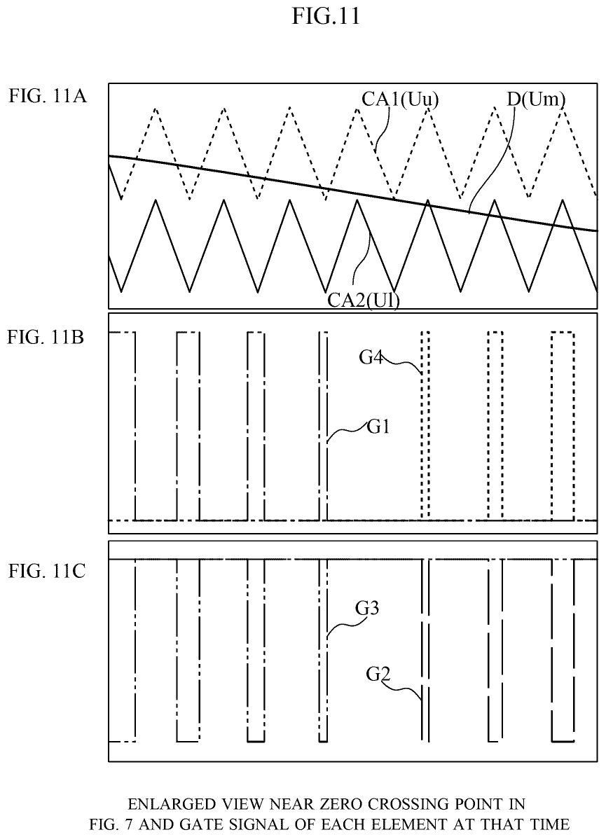

FIG. 11A, FIG. 11B and FIG. 11C are an enlarged view near a zero crossing point in FIG. 7 and a diagram indicating one example of the gate signals G1 to G4 of the semiconductor elements Q1 to Q4 at that time. FIG. 11A indicates an enlarged view near the zero crossing point in FIG. 7. FIG. 11B indicates one example of the gate signals G1 and G4 of the semiconductor elements Q1 and Q4 corresponding to FIG. 11A. FIG. 11C indicates one example of the gate signals G2 and G3 of the semiconductor elements Q2 and Q3 corresponding to FIG. 11A.

FIG. 11A indicates a voltage on a vertical axis and indicates time on a horizontal axis in a similar manner to FIG. 7. Further, a thick solid line at the center indicates a waveform of the modulated wave D, a dashed line in an upper part indicates a waveform of the upper carrier wave CA1, and a solid line in a lower part indicates a waveform of the lower carrier wave CA2. In FIG. 11B and FIG. 11C, in a similar manner to FIG. 9B to FIG. 9E, the gate signals G1 to G4 of the semiconductor elements Q1 to Q4 are generated in accordance with the switching pattern determined in advance indicated in FIG. 8.

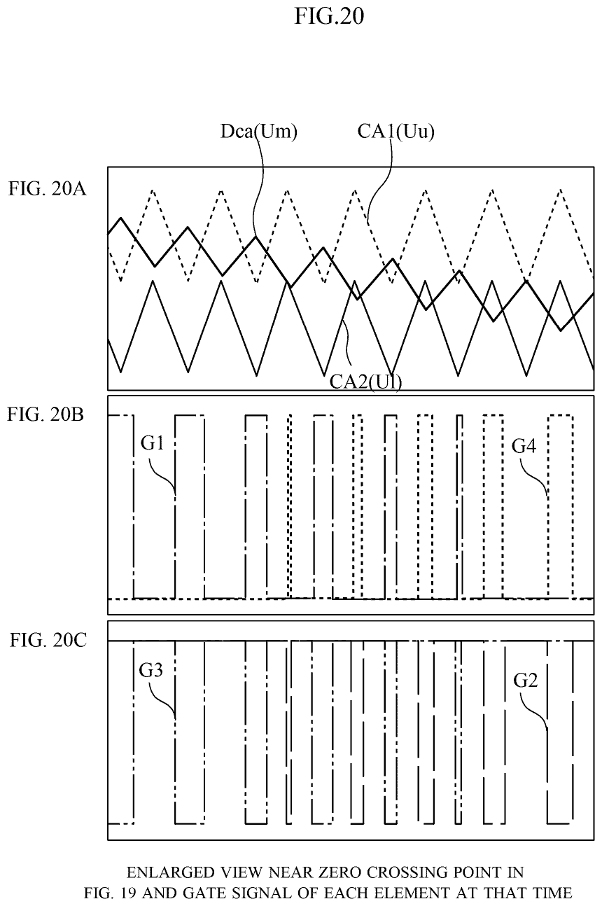

It can be seen from FIG. 11A to FIG. 11C that in a case of the comparative example in which carrier injection control is not performed, switching is performed few times near the zero crossing point. On the other hand, in a case where the carrier injection control according to one embodiment is performed, an interval during which, instead of the semiconductor elements (neutral point elements) Q2 and Q3, the semiconductor elements Q1 and Q4 are conductive occurs near the zero crossing point due to influence of the injection carrier CAin. By this means, in a case where the carrier injection control according to one embodiment is performed, as will be described later, the number of times of switching increases, for example, to approximately double near the zero crossing point (see FIG. 20, and the like).

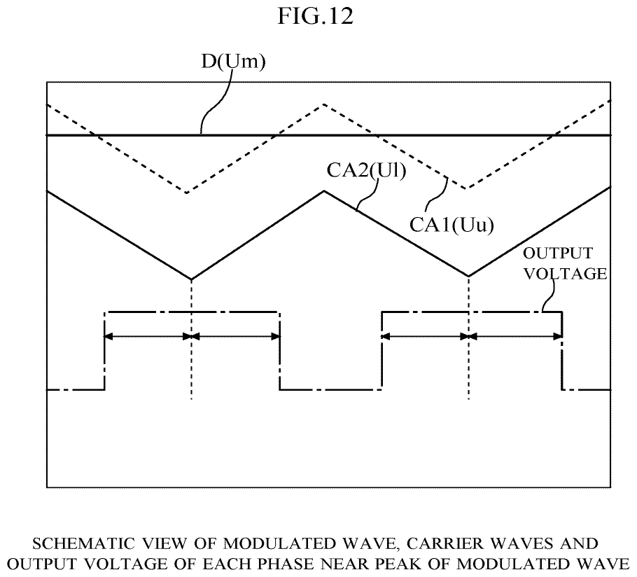

FIG. 12 is a schematic diagram indicating one example of a relationship among the modulated wave D, the carrier waves CA1 and CA2, and an output voltage of each phase near a peak of the modulated wave D indicated in FIG. 7. FIG. 12 indicates a voltage on a vertical axis and indicates time on a horizontal axis in a similar manner to FIG. 7. Further, a thick solid line in an upper part indicates a waveform of the modulated wave D, a dashed line in the upper part indicates a waveform of the upper carrier wave CA1, a solid line at the center indicates a waveform of the lower carrier wave CA2, and a dash-dotted line in a lower part indicates an output voltage pulse of each phase.

As indicated in FIG. 12, a slope of the modulated wave D is substantially 0 (zero) near the peak of the modulated wave D in the upper part, and the center of the output voltage pulse of each phase in the lower part matches bottoms of the carriers of the carrier waves CA1 and CA2. In this case, the fundamental frequency fo of the voltage of each phase becomes the carrier frequency fc.

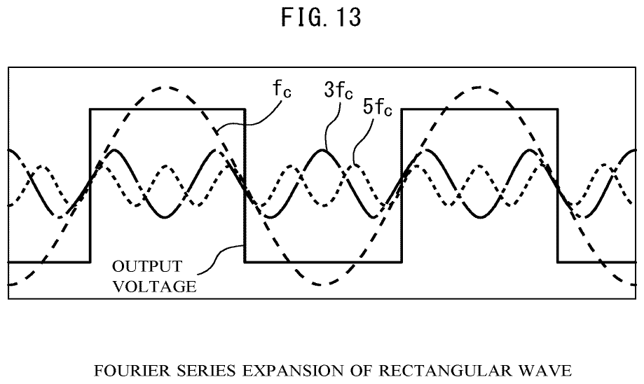

FIG. 13 is a diagram indicating one example of Fourier series expansion of a rectangular wave of the output voltage of each phase indicated in FIG. 12. FIG. 13 indicates a voltage on a vertical axis and indicates time on a horizontal axis. Further, in FIG. 13, a rectangular wave indicated with a solid line indicates a waveform of the output voltage of each phase, each sinusoidal wave indicates a component generated when the output voltage of each phase is subjected to Fourier series expansion. Note that the largest sinusoidal wave indicated with a largest dashed line indicates the carrier frequency fc, a relatively small sinusoidal wave indicated with a solid line indicates a frequency 3fc that is three times as high as the carrier frequency, and the smallest sinusoidal wave indicated with a fine dashed line indicates a frequency 5fc that is five times as high as the carrier frequency.

As indicated in FIG. 13, the output voltage of each phase has a frequency component that is an integral multiple of the carrier frequency fc by being subjected to Fourier transform (Fourier series expansion). The harmonic (such as 3fc and 5fc) that is an integral multiple of the carrier frequency fc described above in FIG. 10 is generated by the principle indicated in FIG. 13.

Here, while the slope of the modulated wave D is substantially 0 (zero) near the peak of the modulated wave D, the slope gradually largely changes as it approaches near the zero crossing point. Thus, near the zero crossing point of the modulated wave D will be considered next.

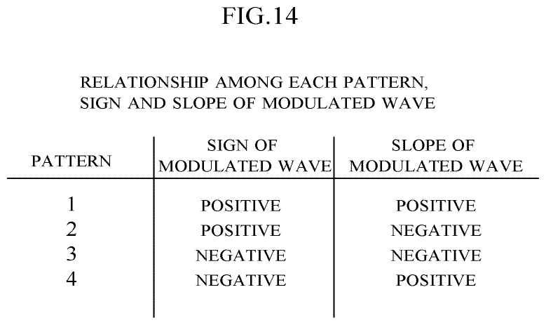

FIG. 14 is a diagram indicating one example of a relationship between a sign of the modulated wave D and the slope of the modulated wave D. A central column in FIG. 14 indicates positive/negative of the sign of the modulated wave D, a right column in FIG. 14 indicates positive/negative of the slope of the modulated wave D, and a left column in FIG. 14 indicates patterns of these relationships.

As indicated in FIG. 14, a pattern 1 is a case where the sign of the modulated wave D is positive, and the slope of the modulated D is also positive. In a similar manner, a pattern 2 is a case where the sign of the modulated wave D is positive, and the slope of the modulated wave D is negative, a pattern 3 is a case where the sign of the modulated wave D is negative, and the slope of the modulated wave D is also negative, and a pattern 4 is a case where the sign of the modulated wave D is negative, and the slope of the modulated wave D is positive. To consider near the zero crossing point of the modulated wave D, intervals of the four patterns indicated in FIG. 14 will be considered below while the sign of the modulated wave D and the slope of the modulated wave D are taken into account.

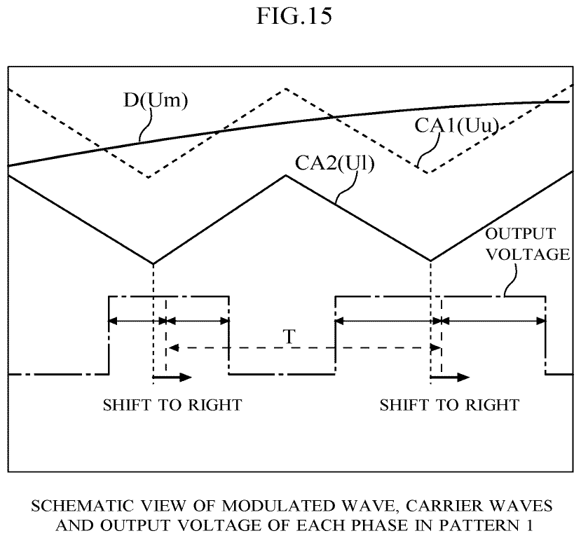

FIG. 15 is a schematic diagram indicating one example of a relationship among the modulated wave D, the carrier waves CA1 and CA2, and the output voltage of each phase in the pattern 1 indicated in FIG. 14. FIG. 15 indicates a voltage on a vertical axis and indicates time on a horizontal axis in a similar manner to FIG. 12. Further, a thick solid line in an upper part indicates a waveform of the modulated wave D, a dashed line in an upper part indicates a waveform of the upper carrier wave CA1, a solid line at the center indicates a waveform of the lower carrier wave CA2, and a dashed-dotted line in a lower part indicates an output voltage pulse of each phase. Note that FIG. 15 indicates a case where the modulated wave D intersects the upper carrier wave CA1, and thus, an upper portion of the pulse indicated with the dashed dotted line in the lower part is a DC voltage, and a lower portion of the pulse is a 1/2 DC voltage.

As indicated in FIG. 15, in the pattern 1 which is a case where the sign of the modulated wave D is positive, and the slope of the modulated wave D is also positive, the center of the output voltage pulse of each phase is shifted to the right side. Thus, a phase difference occurs between the center of the output voltage pulse of each phase in the lower part and the bottoms of the carriers of the carrier waves CA1 and CA2. Further, the slope of the sinusoidal wave increases as it approaches the zero crossing point, and thus, it can be considered that phase shift is greater in the pulse closer to the zero crossing point. Thus, the cycle T of the output voltage of each phase becomes shorter than the carrier cycle.

In other words, in a case of the pattern 1, in FIG. 15, the cycle T from the center of the output voltage pulse to the next center of the output voltage pulse becomes shorter than a cycle from the dashed line extending downward from the bottom of the carrier to the dashed line extending downward from the next bottom of the carrier. In other words, in the interval of the pattern 1, a frequency of the output voltage of each phase becomes greater than the carrier frequency. This becomes a factor of generation of a sideband wave that is a frequency component in a high frequency band/low frequency band centering around the carrier frequency.

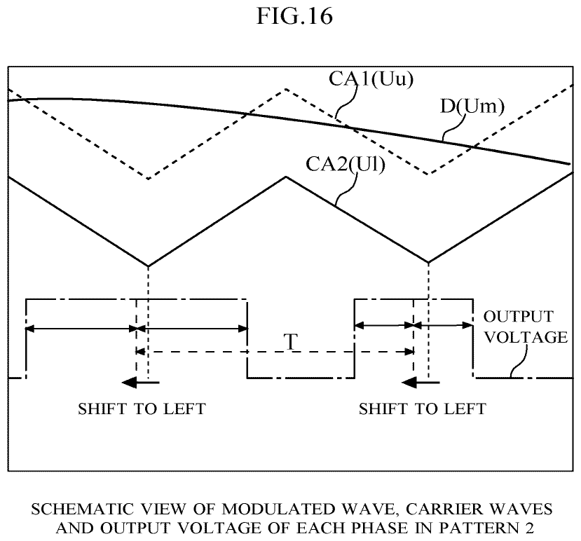

FIG. 16 is a schematic diagram indicating one example of a relationship among the modulated wave D, the carrier waves CA1 and CA2, and the output voltage of each phase in the pattern 2 indicated in FIG. 14. In FIG. 16, what the vertical axis, the horizontal axis, and the respective lines indicate are similar to those in FIG. 15. Note that FIG. 16 indicates a case where the modulated wave D intersects the upper carrier wave CA1, and thus, an upper portion of the pulse indicated with the dashed-dotted line in the lower part is a DC voltage, and a lower portion of the pulse is a 1/2 DC voltage.

As indicated in FIG. 16, in the pattern 2 which is a case where the sign of the modulated wave D is positive, and the slope of the modulated wave D is negative, the center of the output voltage pulse of each phase is shifted to the left side. Thus, a phase difference occurs between the center of the output voltage pulse of each phase in the lower part and the bottoms of the carriers of the carrier waves CA1 and CA2, Further, the slope of the sinusoidal wave increases as it approaches the zero crossing point, and thus, it can be considered that phase shift is greater in the pulse closer to the zero crossing point. Thus, the cycle T of the output voltage of each phase becomes shorter than the carrier cycle.

In other words, in a case of the pattern 2, in FIG. 16, the cycle T from the center of the output voltage pulse to the next center of the output voltage pulse becomes shorter than a cycle from the dashed line extending downward from the bottom of the carrier to the dashed line extending downward from the next bottom of the carrier. In other words, in the interval of the pattern 2, the frequency of the output voltage of each phase becomes greater than the carrier frequency. This becomes a factor of generation of a sideband wave that is a high frequency band/low frequency band centering around the carrier frequency.

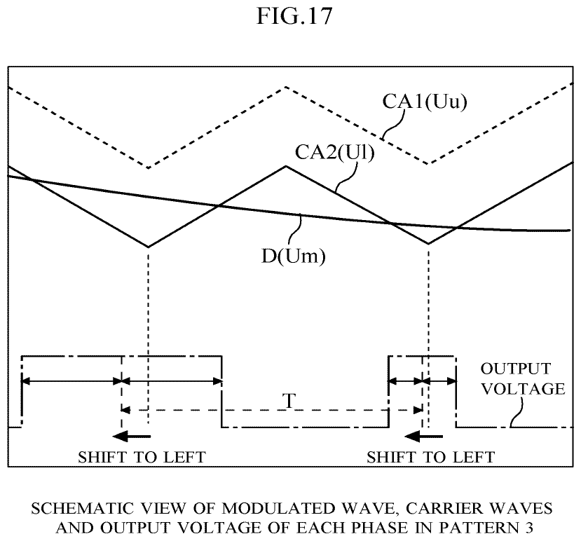

FIG. 17 is a schematic diagram indicating one example of a relationship among the modulated wave D, the carrier waves CA1 and CA2, and the output voltage of each phase in the pattern 3 indicated in FIG. 14. In FIG. 17, what the vertical axis, the horizontal axis and the respective lines indicate are similar to those in FIG. 15. Note that FIG. 17 indicates a case where the modulated wave D intersects the lower carrier wave CA2, and thus, an upper portion of the pulse indicated with the dashed-dotted line in the lower part is a 1/2 DC voltage, and a lower portion of the pulse is 0.

As indicated in FIG. 17, in the pattern 3 which is a case where the sign of the modulated wave D is negative, and the slope of the modulated wave D is also negative, the center of the output voltage of each phase is shifted to the left side. Thus, a phase difference occurs between the center of the output voltage pulse of each phase in the lower part and the bottoms of the carriers of the carrier waves CA1 and CA2, Further, the slope of the sinusoidal wave increases as it approaches the zero crossing point, and thus, it can be considered that phase shift is greater in the pulse closer to the zero crossing point. Thus, the cycle T of the output voltage of each phase becomes longer than the carrier cycle.

In other words, in a case of the pattern 3, in FIG. 17, the cycle T from the center of the output voltage pulse to the next center of the output voltage pulse becomes longer than a cycle from the dashed line extending downward from the bottom of the carrier to the dashed line extending downward from the next bottom of the carrier. In other words, in the interval of the pattern 3, the frequency of the output voltage of each phase becomes smaller than the carrier frequency. This becomes a factor of generation of a sideband wave that is a high frequency band/low frequency band centering around the carrier frequency.

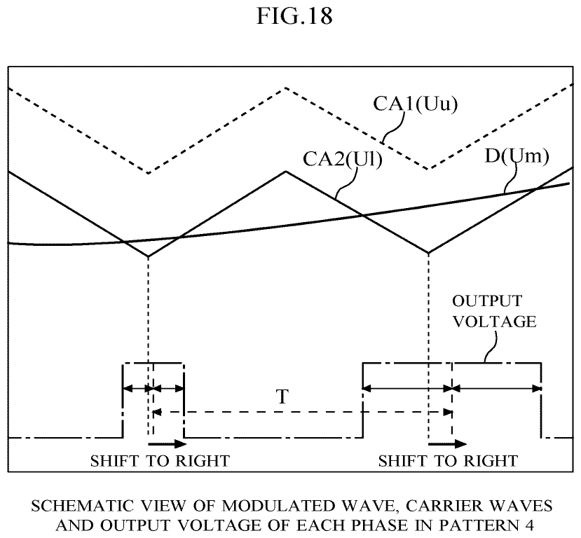

FIG. 18 is a schematic diagram indicating one example of a relationship among the modulated wave D, the carrier waves CA1 and CA2, and the output voltage of each phase in the pattern 4 indicated in FIG. 14. In FIG. 18, what the vertical axis, the horizontal axis and the respective lines indicate are similar to those in FIG. 15. Note that FIG. 18 indicates a case where the modulated wave D intersects the lower carrier wave CA2, and thus, an upper portion of the pulse indicated with the dashed-dotted line in the lower part is a 1/2 DC voltage, and a lower portion of the pulse is 0.

As indicated in FIG. 18, in the pattern 4 which is a case where the sign of the modulated wave D is negative, and the slope of the modulated wave D is positive, the center of the output voltage pulse of each phase is shifted to the right side. Thus, a phase difference occurs between the center of the output voltage pulse of each phase in the lower part and the bottoms of the carriers of the carrier waves CA1 and CA2. Further, the slope of the sinusoidal wave increases as it approaches the zero crossing point, and thus, it can be considered that phase shift is greater in the pulse closer to the zero crossing point. Thus, the cycle T of the output voltage of each phase becomes longer than the carrier cycle.

In other words, in a case of the pattern 4, in FIG. 18, the cycle T from the center of the output voltage pulse to the next center of the output voltage pulse becomes longer than a cycle from a dashed line extending downward from the bottom of the carrier to a dashed line extending downward from the next bottom of the carrier. In other words, in the interval of the pattern 4, the frequency of the output voltage of each phase becomes smaller than the carrier frequency. This becomes a factor of generation of a sideband wave that is a high frequency band/low frequency band centering around the carrier frequency.

As described above, as indicated in FIG. 14 to FIG. 18, in an interval in which the slope of the modulated wave D is great, the frequency of the output voltage of each phase is slightly displaced from the carrier frequency fc. This frequency component slightly displaced from the carrier frequency fc becomes a sideband wave component. In other words, if the output voltage of each phase that becomes a frequency component slightly displaced from the carrier frequency is subjected to Fourier transform (Fourier series expansion) as indicated in FIG. 13, the output voltage of each phase is decomposed into the frequency component slightly displaced from the harmonic component indicated in FIG. 13. The frequency component slightly displaced from the harmonic component becomes a sideband wave component.

Further, a sideband wave component which is close to the carrier frequency fc and which has a large spectrum is generated near the zero crossing point at which a change rate of the slope is small. In other words, as described from the pattern 1 to the pattern 4 in FIG. 15 to FIG. 18, as a result of the slope of the modulated wave D changing, the frequency of the output voltage of each phase is displaced from the carrier frequency fc, and this displacement of the frequency becomes a factor of generation of a sideband wave.

Here, a level of displacement of the frequency becomes smaller as the change rate of the slope of the modulated wave D is smaller. Near the zero crossing point of the modulated wave D, the change rate of the slope is small, and thus, displacement of the frequency of the output voltage of each phase becomes relatively small. It can be therefore considered that the sideband wave having a relatively low frequency band (frequency component relatively close to the carrier frequency fc) in FIG. 10 is generated near the zero crossing point of the modulated wave D. On the other hand, the change rate of the slope is large near the peak of the modulated wave D, and thus, displacement of the frequency of the output voltage of each phase becomes relatively large. It can be therefore considered that the sideband wave having a relatively high frequency band (frequency component relatively far from the carrier frequency fc) in FIG. 10 is generated near the peak of the modulated wave D.

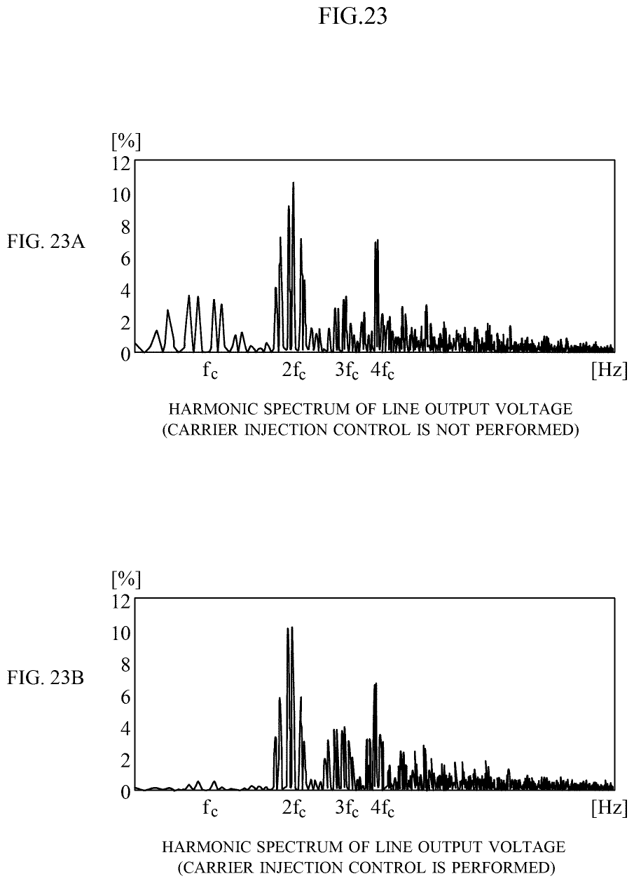

As described in FIG. 10, the harmonic component in the relatively high frequency band (for example, a right side in FIG. 10) does not become a big problem because energy can be easily attenuated by the filter. On the other hand, the harmonic component in the relatively low frequency band (for example, a left side in FIG. 10) becomes a problem because a large filter is required to attenuate the harmonic component. Concerning this point, in a case where the carrier injection control according to one embodiment is performed, the switching pattern changes near the zero crossing point, and thus, it is possible to take measures near the zero crossing point with high accuracy (see FIG. 20, and the like). By this means, in a case where the carrier injection control according to one embodiment is performed, a sideband wave component having a large spectrum near the carrier frequency fo that is a relatively high frequency band can be effectively reduced with high accuracy (see FIG. 23, and the like).

### Processing (Operation) of One Embodiment

Processing (operation) of one embodiment indicated from FIG. 1 to FIG. 5 will be described next on the premise of generation principle of the harmonic described using the comparative example indicated from FIG. 6 to FIG. 18.

FIG. 19 is a diagram indicating one example of a relationship between the carrier waves CA1 and CA2 and the modulated wave Dca in a case where carrier injection control is performed in the gate signal generation unit 53 according to one embodiment illustrated in FIG. 5. FIG. 19 indicates a voltage on a vertical axis and indicates time on a horizontal axis in a similar manner to FIG. 7. Further, a thick solid line at the center indicates a waveform of the modulated wave Dca subjected to carrier injection control, a dashed line in an upper part indicates a waveform of the upper carrier wave CA1, and a solid line in a lower part indicates a waveform of the lower carrier wave CA2.

As indicated in FIG. 19, the carrier level shift modulation scheme in a case where carrier injection control is performed is a modulation scheme of generating the gate signals G1 to G4 of the semiconductor elements Q1 to Q4 by comparing the carrier waves CA1 and CA2 with the modulated wave Dca subjected to carrier injection control. In other words, in the carrier level shift modulation in which carrier injection control is performed, as described in FIG. 5, the gate signal generation unit 53 obtains the modulated wave Dca subjected to carrier injection control by superimposing the modulated wave D on the injection carrier CAin. Then, the gate signal generation unit 53 compares magnitudes of the carrier waves CA1 and CA2 generated by the carrier generators 61 and 62 with a magnitude of the obtained modulated wave Dca and, for example, generates the gate signals G1 to G4 in accordance with the switching pattern determined in advance indicated in FIG. 8. Note that as described in FIG. 5, the injection carrier CAin is a triangle wave signal which changes in a range from a to −a (predetermined amplitude range), which has a phase opposite to the phase of the triangle wave carriers (carrier waves) CA1 and CA2, and which has the same carrier cycle as the carrier cycle.

FIG. 20A, FIG. 20B and FIG. 20C are an enlarged view near the zero crossing point in FIG. 19 and a diagram indicating one example of the gate signals G1 to G4 of the semiconductor elements Q1 to Q4 at that time. FIG. 20A indicates an enlarged view near the zero crossing point in FIG. 19. FIG. 20B indicates one example of the gate signals G1 and G4 of the semiconductor elements Q1 and Q4 corresponding to FIG. 20A. FIG. 20C indicates one example of the gate signals G2 and G3 of the semiconductor elements Q2 and Q3 corresponding to FIG. 20A.

FIG. 20A indicates a voltage on a vertical axis and indicates time on a horizontal axis in a similar manner to FIG. 7. Further, a thick solid line at the center indicates a waveform of the modulated wave Dca subjected to carrier injection control, a dashed line in an upper part indicates a waveform of the upper carrier wave CA1, and a solid line in a lower part indicates a waveform of the lower carrier wave CA2. In FIG. 20B and FIG. 20C, in a similar manner to FIG. 11B and FIG. 11C, the gate signals G1 to G4 of the semiconductor elements Q1 to Q4 are generated, for example, in accordance with the switching pattern determined in advance indicated in FIG. 8.

According to FIG. 20A to FIG. 20C, in a case where carrier injection control is performed, the number of times of switching increases, for example, to approximately double near the zero crossing point, compared to a case where carrier injection control is not performed indicated in FIG. 11A to FIG. 11C. This is because, in a case where carrier injection control is performed, an interval in which, instead of the semiconductor elements (neutral point elements) Q2 and Q3, the semiconductor elements Q1 and Q4 are conductive occurs near the zero crossing point due to influence of the injection carrier CAin.

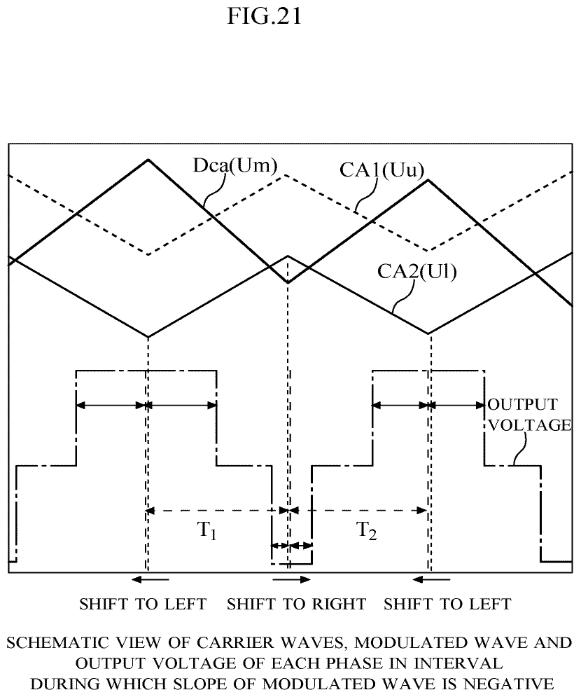

FIG. 21 is a schematic diagram indicating one example of a relationship among the modulated wave Dca, the carrier waves CA1 and CA2, and the output voltage of each phase in a period during which the slope of the modulated wave Dca is negative. FIG. 21 indicates a voltage on a vertical axis and indicates time on a horizontal axis in a similar manner to FIG. 15 to FIG. 18. Further, a thick solid line in an upper part indicates a waveform of the modulated wave Dca subjected to carrier injection control, a dashed line in the upper part indicates a waveform of the upper carrier wave CA1, a solid line at the center indicates a waveform of the lower carrier wave CA2, and a dashed-dotted line in a lower part indicates an output voltage pulse of each phase. Note that FIG. 21 indicates a case where the modulated wave Dca intersects both the upper carrier wave CA1 and the lower carrier wave CA2, and thus, an upper most portion of the pulse indicated with the dashed-dotted line in the lower part indicates a DC voltage, a central portion of the pulse indicates a 1/2 DC voltage, and a lower most portion of the pulse indicates 0.

As indicated in FIG. 21, in a case of the patterns 2 and 3 indicated in FIG. 14 which are periods during which the slope of the modulated wave Dca is negative, the center of the crest of the output voltage pulse of each phase is shifted to the left side from the bottom of the carrier. On the other hand, in this case, the center of the bottom of the output voltage pulse of each phase is shifted to the right side from the crest of the carrier. Thus, the frequency of the output voltage of each phase in an interval T1 becomes smaller than the carrier frequency fc. On the other hand, the frequency of the output voltage of each phase in an interval T2 becomes greater than the carrier frequency fc.

In other words, in FIG. 21, in a case where the slope of the modulated wave Dca is negative, the interval T1 from the center of the crest of the output voltage pulse in the left part to the center of the next bottom of the output voltage pulse becomes longer than a cycle from a dashed line extending downward from the bottom of the carrier in the left part to a dashed line extending downward from the next crest of the carrier. In other words, as indicated in FIG. 21, the interval T1 becomes longer than a half cycle of the carrier waves CA1 and CA2, and thus, in the interval T1, the frequency of the output voltage of each phase becomes smaller than the carrier frequency fc.

On the other hand, in this case, in FIG. 21, the interval T2 from the center of the bottom of the output voltage pulse at the center to the center of the next crest of the output voltage pulse becomes shorter than a cycle from a dashed line extending downward from the crest of the carrier at the center to a dashed line extending downward from the next bottom of the carrier. In other words, as indicated in FIG. 21, the interval T2 becomes shorter than a half cycle of the carrier waves CA1 and CA2, and thus, in the interval T2, the frequency of the output voltage of each phase becomes greater than the carrier frequency fc.

In this manner, in a case of the patterns 2 and 3 indicated in FIG. 14 which are periods during which the slope of the modulated wave Dca is negative, the output voltage of each phase includes the interval T1 during which the frequency is lower than the carrier frequency fc and the interval T2 during which the frequency is higher than the carrier frequency fc within one cycle,

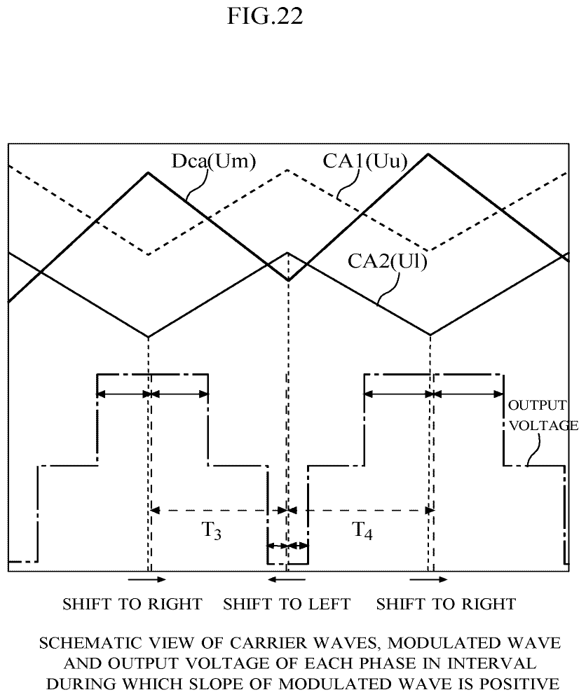

FIG. 22 is a schematic diagram indicating one example of a relationship among the modulated wave Dca, the carrier waves CA1 and CA2, and the output voltage of each phase in a period during which the slope of the modulated wave Dca is positive. FIG. 22 indicates a voltage on a vertical axis and indicates time on a horizontal axis in a similar manner to FIG. 15 to FIG. 18. Further, a thick solid line in an upper part indicates a waveform of the modulated wave Dca subjected to carrier injection control, a dashed line in the upper part indicates a waveform of the upper carrier wave CA1, a solid line at the center indicates a waveform of the lower carrier wave CA2, and a dashed-dotted line in a lower part indicates the output voltage pulse of each phase. Note that FIG. 22 indicates a case where the modulated wave Dca intersects both the upper carrier wave CA1 and the lower carrier wave CA2, and thus, an upper most portion of the pulse indicated with the dashed-dotted line in the lower part indicates a DC voltage, a central portion of the pulse indicates a 1/2 DC voltage, and a lower most portion of the pulse indicates 0.

As indicated in FIG. 22, in a case of the patterns 1 and 4 indicated in FIG. 14 which are periods during which the slope of the modulated wave Dca is positive, the center of the crest of the output voltage pulse of each phase is shifted to the right side from the bottom of the carrier. On the other hand, in this case, the center of the bottom of the output voltage pulse of each phase is shifted to the left side from the crest of the carrier. Thus, the frequency of the output voltage of each phase in an interval T3 becomes greater than the carrier frequency fc. On the other hand, the frequency of the output voltage of each phase in an interval T4 becomes smaller than the carrier frequency fc.

In other words, in FIG. 22, in a case where the slope of the modulated wave Dca is positive, the interval T3 from the center of the crest of the output voltage pulse in the left part to the center of the next bottom of the output voltage pulse becomes shorter than a cycle from a dashed line extending downward from the bottom of the carrier in the left part to a dashed line extending downward from the next crest of the carrier. In other words, as indicated in FIG. 22, the interval T3 becomes shorter than a half cycle of the carrier waves CA1 and CA2, and thus, in the interval T3, the frequency of the output voltage of each phase becomes greater than the carrier frequency fc.

On the other hand, in this case, in FIG. 22, the interval T4 from the center of the bottom of the output voltage pulse at the center to the next center of the crest of the output voltage pulse becomes longer than a cycle from a dashed line extending downward from the crest of the carrier at the center to a dashed line extending downward from the next bottom of the carrier. In other words, as indicated in FIG. 22, the interval T4 becomes longer than a half cycle of the carrier waves CA1 and CA2, and thus, in the interval T4, the frequency of the output voltage of each phase becomes shorter than the carrier frequency fc.

In this manner, in a case of the patterns 1 and 4 indicated in FIG. 14 which are periods during which the slope of the modulated wave Dca is positive, the output voltage of each phase includes the interval T3 during which the frequency is higher than the carrier frequency fc and the interval T4 during which the frequency is lower than the carrier frequency fc within one cycle.

As described above, it can be seen from FIG. 21 and FIG. 22 that a phase difference of 180 degrees exists between the output voltage of each phase in a case where the slope of the modulated wave Dca is positive and the output voltage of each phase in a case where the slope of the modulated wave Dca is negative. In this case, a sideband wave generated in a case where the slope of the modulated wave Dca is positive and a sideband wave generated in a case where the slope of the modulated wave Dca is negative cancel out each other. In other words, for example, assuming that the cycle T of Fourier series expansion is the fundamental frequency fo (for example, 50 Hz or 60 Hz), high frequency components which have an equal amplitude and which have a phase difference of 180 degrees cancel out each other by integral calculation within the cycle T of the Fourier series expansion. Thus, these components do not appear in the harmonic spectrum. Thus, in a case where carrier injection control is performed, a sideband wave component of the carrier frequency fc can be reduced.

### Operational Effects of One Embodiment

FIG. 23A and FIG. 23B are diagrams indicating one example of a harmonic spectrum of a line output voltage standardized with a DC voltage in a case where carrier injection control is not performed and in a case where carrier injection control is performed, FIG. 23A indicates one example of a harmonic spectrum of a line output voltage standardized with a DC voltage in the power conversion system 120 in which carrier injection control is not performed according to the comparative example indicated in FIG. 6 to FIG. 18. FIG. 23B indicates one example of a harmonic spectrum of a line output voltage standardized with a DC voltage in the power conversion system 20 in which carrier injection control is performed according to one embodiment indicated in FIG. 1 to FIG. 5 and FIG. 19 to FIG. 22.

FIGS. 23A and 23B indicate a magnitude of the harmonic spectrum on a vertical axis and indicate a frequency on a horizontal axis. Further, fc indicates a frequency component of the carrier frequency, and 2fc to 4fc indicate a frequency component that is an integral multiple of the carrier frequency fc.

As indicted in FIG. 23A, in a case where carrier injection control is not performed, the sideband wave component spreads in a high frequency band and a low frequency band of each harmonic that is an integral multiple of the carrier frequency fc, and the sideband wave component also spreads near the carrier frequency fc that is a relatively low frequency band. On the other hand, as indicated in FIG. 23B, in a case where carrier injection control is performed, while the sideband wave component spreads in a high frequency band and a low frequency band of each harmonic that is an integral multiple of the carrier frequency fc, the sideband wave component does not spread near the carrier frequency fc that is a relatively low frequency band.

In other words, as indicated in FIGS. 23A and 23B, in a case where carrier injection control is used, the sideband wave component near the carrier frequency fc becomes smaller and reduced than that in a case where carrier injection control is not used. It can be considered from this that a harmonic of the output line voltage becomes smaller by carrier injection control according to one embodiment being performed, and thus, an output harmonic current of the power converter (inverter) 30 becomes smaller.

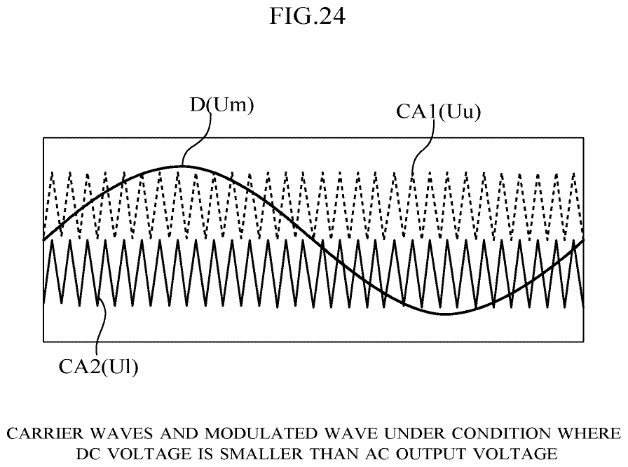

Thus, according to one embodiment indicated in FIG. 1 to FIG. 5 and FIG. 19 to FIG. 22, it is possible to reduce a harmonic near the carrier frequency fc that is a harmonic component in a relatively low frequency band compared to the related art in the power converter 30 in which the carrier level shift modulation scheme is used. By this means, according to one embodiment, as described in FIGS. 23 and 24, it is possible to reduce an output harmonic current compared to the related art.

Further, according to one embodiment indicated in FIG. 1 to FIG. 5 and FIG. 19 to FIG. 22, it is possible to prevent increase in size and cost of an apparatus. In other words, as described in FIG. 10, it has been necessary in the related art to increase a size of a filter to attenuate a harmonic component in a relatively low frequency band, which has led to increase in size and cost of the apparatus. On the other hand, in a case where carrier injection control according to one embodiment is performed, it is possible to reduce (occurrence of) a harmonic itself near the carrier frequency fc compared to the related art instead of attenuating a harmonic generated near the carrier frequency fc that is a harmonic component in a relatively low frequency band. Further, this can be processed in a software manner, so that it is possible to reduce cost compared to a case where hardware is added (compared to a case where a size of the filter is physically increased). Thus, according to one embodiment, processing can be performed in a software manner, so that it is not necessary to physically increase a size of the filter, and it is possible to prevent increase in size and cost of the apparatus compared to the related art.

Further, according to one embodiment indicated in FIG. 1 to FIG. 5 and FIG. 19 to FIG. 22, a harmonic of the output voltage becomes smaller by carrier injection control. Thus, according to one embodiment, in a case where a filter capacitor is used on an AC side, it is possible to reduce an AC capacitor current flowing through the filter capacitor compared to the related art. By this means, as a result of the AC capacitor current becoming smaller, it is possible to prevent hent generation of the capacitor compared to the related art, so that it is possible to extend a length of life of the capacitor compared to the related art.

FIG. 24 is a diagram indicating one example of the carrier waves CA1 and CA2 and the modulated wave D under a condition that the DC voltage is smaller than the AC output voltage. FIG. 24 indicates a voltage on a vertical axis and indicates time on a horizontal axis in a similar manner to FIG. 7. Further, a thick solid line at the center indicates a waveform of the modulated wave D, a dashed line in an upper part indicates a waveform of the upper carrier wave CA1, and a solid line in a lower part indicates a waveform of the lower carrier wave CA2.

Typically, an effective value of the output line voltage with respect to the DC voltage is called a DC voltage utilization ratio. The power converter (inverter) 30 is directed to converting a DC voltage to obtain a desired AC voltage. It is therefore desired that the power converter (inverter) 30 has a high DC voltage utilization ratio. Here, a case will be assumed where the power converter (inverter) 30 is caused to operate under a condition where the DC voltage is smaller than the AC output voltage. In this case, as indicated in FIG. 24, a maximum value of the modulated wave D becomes greater than maximum values of the carrier waves CA1 and CA2, and overmodulation occurs.

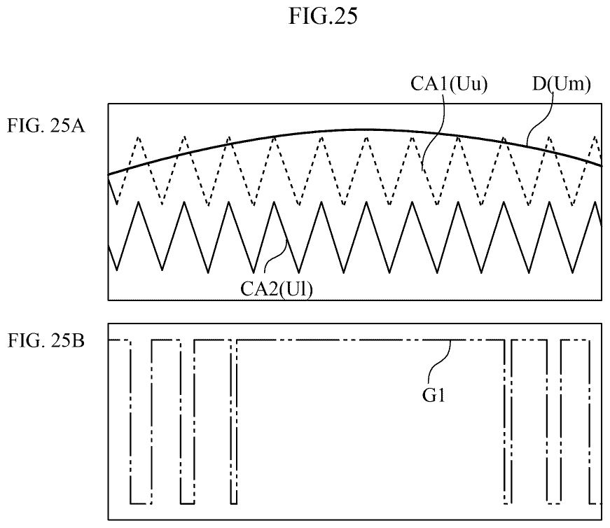

FIG. 25A and FIG. 25B are an enlarged view near a peak of the modulated wave D in FIG. 24 and a diagram indicating one example of the gate signal G1. FIG. 25A indicates an enlarged view near the peak of the modulated wave D in FIG. 24. FIG. 25B indicates one example of the gate signal G1 of the semiconductor element Q1 corresponding to FIG. 25A.

FIG. 25A indicates a voltage on a vertical axis and indicates time on a horizontal axis in a similar manner to FIG. 24. Further, a thick solid line at the center indicates a waveform of the modulated wave D, a dashed line in an upper part indicates a waveform of the upper carrier wave CA1, and a solid line in a lower part indicates a waveform of the lower carrier wave CA2. In FIG. 25B, the gate signal G1 of the semiconductor element Q1 is generated, for example, in accordance with the switching pattern determined in advance indicated in FIG. 8.

Here, for example, in the circuit illustrated in FIG. 2, in a case where the semiconductor element Q1 or Q4 is conductive, an amplitude of the output voltage of the power converter (inverter) 30 becomes an amplitude of a DC voltage, and the output voltage becomes equal to the DC voltage. On the other hand, in a case where the semiconductor element (neutral point element) Q2 or Q3 is conductive, the DC neutral point C becomes conductive, and thus, the amplitude of the output voltage of the power converter (inverter) 30 becomes half of the amplitude of the DC voltage, and the output voltage becomes smaller than that in a case where the semiconductor element Q1 or Q4 is conductive. The power converter (inverter) 30 basically cuts out the DC voltage to generate an AC output voltage. Thus, in a case where the semiconductor element Q1 or Q4 is conductive, the DC voltage itself is cut out, and thus, a large output can be obtained. However, in a case where the semiconductor element (neutral point element) Q2 or Q3 is conductive, the DC neutral point C becomes conductive, and thus, a small voltage is output. Thus, within one cycle of a fundamental wave, as a conducting period of the semiconductor element Q1 or Q4 is longer, the AC output voltage becomes greater. Note that as the amplitude of the modulated wave D is greater, the conducting period of the semiconductor element Q1 or Q4 increases.

Here, as indicated in FIG. 25A, if the maximum value of the modulated wave D becomes greater than the maximum values of the carrier waves CA1 and CA2, and overmodulation occurs, as indicated in FIG. 25B, an interval during which switching cannot be performed occurs, and thus, appropriate control is not performed.

For example, in a case where the AC voltage is greater than the DC voltage, the power converter (inverter) 30 has to output the great AC voltage, and thus, it is necessary to increase the conducting period of the semiconductor element Q1 or Q4 as long as possible. However, for example, as indicated in FIG. 25A, in a case where the modulated wave D is greater than the carrier waves CA1 and CA2 (in this case, typically referred to as overmodulation), an interval during which switching cannot be performed occurs, and thus, the power converter (inverter) 30 cannot output a desired AC voltage. Thus, the power converter (inverter) 30 cannot output a desired AC voltage in the interval during which switching cannot be performed under a condition where the DC voltage is smaller than the AC output voltage, which degrades a DC voltage utilization ratio.

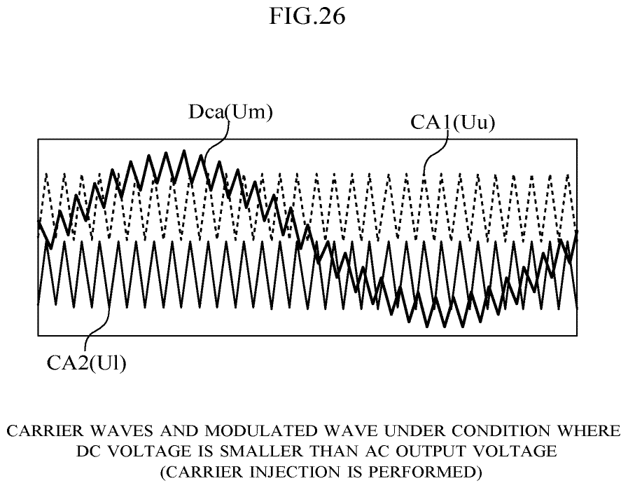

FIG. 26 is a diagram indicating one example of the carrier waves CA1 and CA2 and the modulated wave Dca subjected to carrier injection control under a condition where the DC voltage is smaller than the AC output voltage. FIG. 26 indicates a voltage on a vertical axis and indicates time on a horizontal axis in a similar manner to FIG. 7. Further, a thick solid line at the center indicates a waveform of the modulated wave Dca, a dashed line in an upper part indicates a waveform of the upper carrier wave CA1, and a solid line in a lower part indicates a waveform of the lower carrier wave CA2.

In FIG. 26, in a similar manner to FIGS. 24 and 25, the maximum value of the modulated wave Dca is greater than the maximum values of the carrier waves CA1 and CA2. However, on the modulated wave Dca, carrier injection control of injecting the injection carrier CAin which has the same carrier cycle as the carrier cycle of CA1 and CA2 and which has a phase opposite to the cycle of the carrier (that is, having a phase difference of 180 degrees) of the CA1 and CA2 is performed.

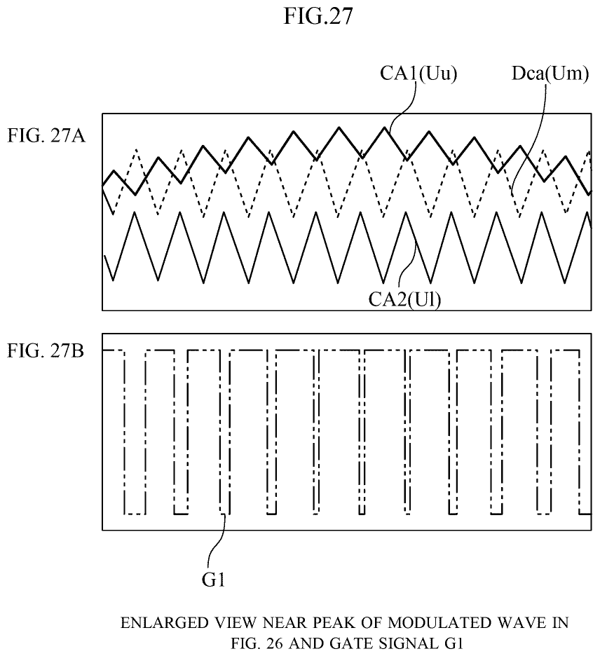

FIG. 27A and FIG. 27B are an enlarged view near a peak of the modulated wave Dca in FIG. 26 and a diagram indicating one example of the gate signal G1 at that time. FIG. 27A indicates an enlarged view near the peak of the modulated wave Dca in FIG. 26. FIG. 27B indicates one example of the gate signal G1 of the semiconductor element Q1 corresponding to FIG. 27A.

FIG. 27A indicates a voltage on a vertical axis and indicates time on a horizontal axis in a similar manner to FIG. 26. Further, a thick solid line at the center indicates a waveform of the modulated wave Dca, a dashed line in an upper part indicates a waveform of the upper carrier wave CA1, and a solid line in a lower part indicates a waveform of the lower carrier wave CA2. In FIG. 27B, the gate signal G1 of the semiconductor element Q1 is generated, for example, in accordance with the switching pattern determined in advance indicated in FIG. 8.

Here, as described in FIG. 25, within one cycle of a fundamental wave, as the conducting period of the semiconductor element Q1 or Q4 is longer, the AC output voltage becomes greater. Further, as the amplitude of the modulated wave Dca is greater, the conducting period of the semiconductor element Q1 or Q4 increases. Concerning this point, as indicated in FIG. 27A, on the modulated wave Dca, carrier injection control of injecting the injection carrier CAin having a phase difference of 180 degrees between CA1 and CA2 is performed, and thus, the modulated wave Dca can have many intersecting points with the carrier waves CA1 and CA2. In this case, as indicated in FIG. 27B, also near the peak of the modulated wave Dca, switching is performed by the gate signal G1 at the semiconductor element Q1. By this means, if carrier injection control is performed, an interval during which switching cannot be performed is reduced, so that the power converter (inverter) 30 can output a desired AC voltage also under a condition where the DC voltage is smaller than the AC output voltage, Thus, if carrier injection control is performed, it is possible to improve a DC voltage utilization ratio compared to the related art.

Thus, according to one embodiment indicated in FIG. 1 to FIG. 5 and FIG. 19 to FIG. 22, carrier injection control is used, so that it is possible to output a desired AC voltage with a small DC voltage compared to a case where carrier injection control is not used. By this means, according to one embodiment in which carrier injection control is used, it is possible to improve a DC voltage utilization ratio of the power converter (inverter) 30 compared to a case where carrier injection control is not used.

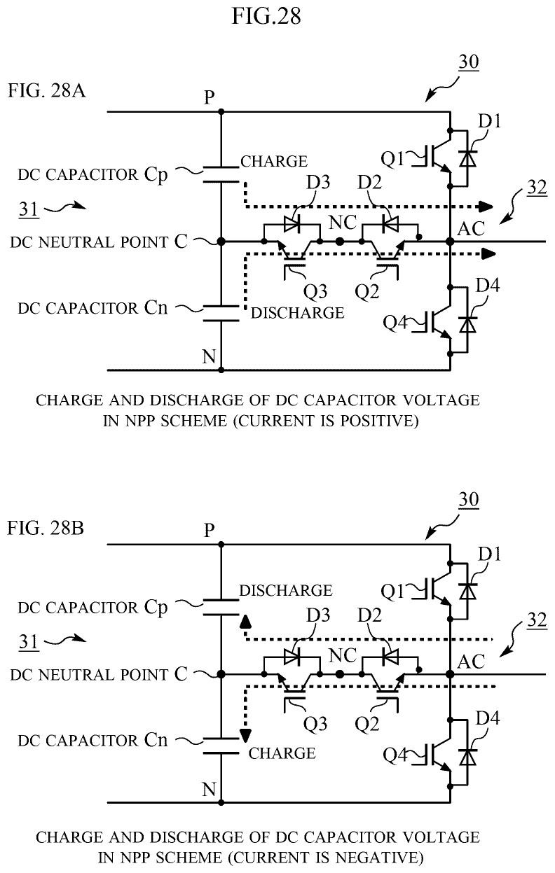

FIGS. 28A and 28B are diagrams illustrating one example of charge and discharge of voltages of DC capacitors Cp and Cn in a circuit configuration corresponding to one phase, employing the three-level NPP scheme illustrated in FIG. 2. FIG. 28A illustrates one example of charge and discharge of voltages of the DC capacitors Cp and Cn in a case where the current is positive in the circuit configuration corresponding to one phase, employing the three-level NPP scheme illustrated in FIG. 2. FIG. 28B illustrates one example of charge and discharge of voltages of the DC capacitors Cp and Cn in a case where the current is negative in the circuit configuration corresponding to one phase, employing the three-level NPP scheme illustrated in FIG. 2.

Here, a switching pattern in which the semiconductor elements (neutral point elements) Q2 and Q3 are conductive in a case illustrated in FIG. 28 will be considered. For example, as illustrated in FIG. 28A, in a case where the current is positive, the DC capacitor Cp is charged, and the DC capacitor Cn is discharged. On the other hand, as illustrated in FIG. 28B, in a case where the current is negative, the DC capacitor Cp is discharged, and the DC capacitor Cn is charged. Thus, in the power converter (inverter) 30 having the DC neutral point C, pulsation occurs in the DC neutral point voltage as a result of the semiconductor elements (neutral point elements) Q2 and Q3 being conductive.

In other words, as illustrated in FIGS. 28A and 28B, in the power converter (inverter) 30 having the DC neutral point C, every time the semiconductor elements (neutral point elements) Q2 and Q3 become conductive, the DC capacitors Cp and Cn are charged or discharged, and pulsation occurs in the DC capacitor voltage. As a result of this, pulsation occurs at the DC neutral point C in accordance with the switching pattern. Concerning this point, if carrier injection control is performed, a period during which the modulated wave Dca becomes greater than the upper carrier wave CA1 or smaller than the lower carrier wave CA2 increases, and the conducting periods of the semiconductor elements Q1 and Q4 increase. In other words, a period during which the modulated wave Dca exists between the upper carrier wave CA1 and the lower carrier wave CA2 decreases, and the conducting periods of the semiconductor elements (neutral point elements) Q2 and Q3 decrease. As a result, a pattern itself in which the semiconductor elements (neutral point elements) Q2 and Q3 are conductive and which causes pulsation decreases, and thus, pulsation itself of the capacitor voltage decreases. Thus, according to one embodiment, an effect of reducing the conducting periods of the semiconductor elements (neutral point elements) Q2 and Q3 near the zero crossing point is provided, so that it is possible to reduce pulsation of the DC neutral point voltage compared to the related art.

Thus, according to one embodiment indicated in FIG. 1 to FIG. 5 and FIG. 19 to FIG. 22, carrier injection control is performed, and thus, conduction amounts at the semiconductor elements (neutral point elements) Q2 and Q3 decrease compared to a case where carrier injection control is not performed. By this means, according to one embodiment in which carrier injection control is performed, it is possible to reduce pulsation of the DC neutral point voltage compared to a case where carrier injection control is not performed.

Further, according to one embodiment indicated in FIG. 1 to FIG. 5 and FIG. 19 to FIG. 22, carrier injection control is performed, and thus, as described above, conduction amounts at the semiconductor elements (neutral point elements) Q2 and Q3 decrease compared to a case where carrier injection control is not performed. By this means, according to one embodiment, conduction losses of the semiconductor elements (neutral point elements) Q2 and Q3 decrease, so that it is possible to reduce heat generation at the semiconductor elements (neutral point elements) Q2 and Q3 compared to a case where carrier injection control is not performed.

Note that while in one embodiment indicated in FIG. 1 to FIG. 5 and FIG. 19 to FIG. 22, a case has been described as an example where the injection carrier is a triangle wave, the injection carrier is not limited to this, and the injection carrier may be any wave other than the triangle wave if the signal has the same cycle as the cycle of the carrier waves CAL and CA2 and has a phase opposite to the phase of the carrier waves CA1 and CA2. Even if the injection carrier is a wave other than the triangle wave, for example, a sinusoidal wave, a rectangular wave, or the like, operational effects similar to those in one embodiment indicated in FIG. 1 to FIG. 5 and FIG. 19 to FIG. 22 are provided.

### Modification of One Embodiment

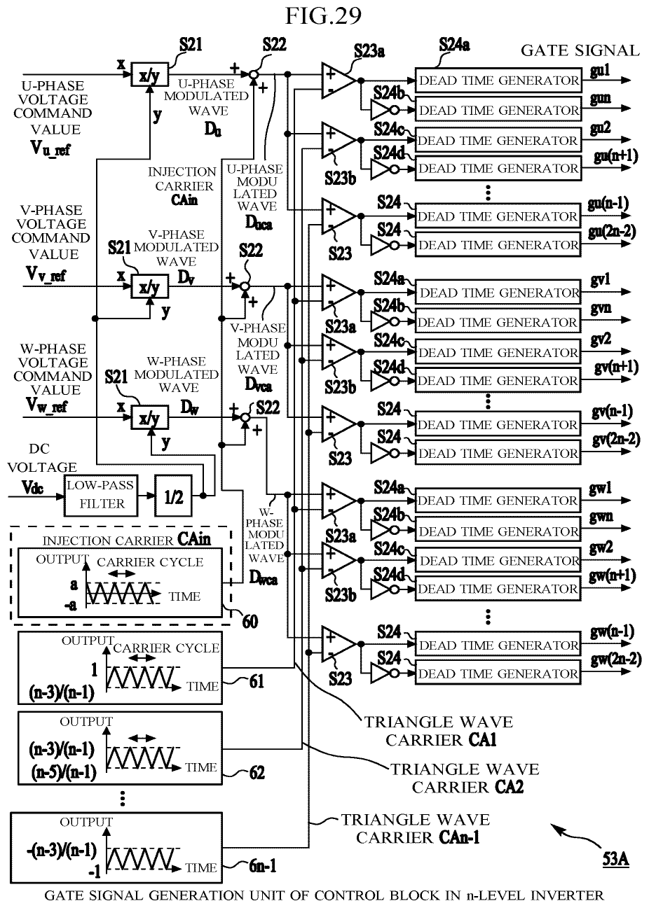

FIG. 29 is a diagram illustrating one example of a control configuration in a gate signal generation unit 53A according to a modification of one embodiment. While FIG. 29 illustrates a control configuration example of three phases of a U phase, a V phase and a W phase, in the following description, control of the U phase will be described as an example for control common among the respective phases in a similar manner to FIG. 5.

Note that in the modification of one embodiment illustrated in FIG. 29, the gate signal generation unit 53 illustrated in FIG. 3 and FIG. 5 in the power conversion system 20 according to one embodiment indicated in FIG. 1 to FIG. 5 and FIG. 19 to FIG. 22 is replaced with the gate signal generation unit 53A. Further, while not illustrated, in the modification of one embodiment illustrated in FIG. 29, the three-level power converter 30 in the power conversion system 20 according to one embodiment is replaced with an n-level power converter 30A. Other components in the power conversion system 20A according to the following modification of one embodiment are the same as or similar to the components in the power conversion system 20 according to one embodiment indicated in FIG. 1 to FIG. 5 and FIG. 19 to FIG. 22. Thus, in the following modification of one embodiment, the components that are the same as or similar to the components in the power conversion system 20 according to one embodiment indicated in FIG. 1 to FIG. 5 and FIG. 19 to FIG. 22 will be denoted by the same reference numerals, and detailed description and illustration will be omitted.

As described in FIG. 1 to FIG. 5 and FIG. 19 to FIG. 22, the gate signal generation unit 53 according to one embodiment is the gate signal generation unit 53 in the three-level power converter (inverter) 30. On the other hand, the gate signal generation unit 53A according to the modification of one embodiment illustrated in FIG. 29 is the gate signal generation unit 53A in the n-level power converter (inverter) 30A. Thus, the gate signal generation unit 53A according to the modification of one embodiment illustrated in FIG. 29 includes carrier generators 63, 64, . . . , 6n-1 in addition to the carrier generators 61 and 62. By this means, in the gate signal generation unit 53A, carrier waves CA3, CA4 . . . , CAn−1 are generated in addition to the carrier waves CA1 and CA2. By this means, the gate signal generation unit 53A generates and outputs a gate signal G in accordance with the n level in addition to the gate signals Gu1 to Gu4. Note that the gate signal generation unit 53A generates and outputs the gate signal G in accordance with the n level in addition to the gate signals Gv1 to Gv4 and Gw1 to Gw4 also for the V phase and the W phase in a similar manner to the U phase.

As described above, in the modification of one embodiment illustrated in FIG. 29, operational effects similar to the operational effects of one embodiment indicated in FIG. 1 to FIG. 5 and FIG. 19 to FIG. 22 are provided. In other words, in one embodiment indicated in FIG. 1 to FIG. 5 and FIG. 19 to FIG. 22, the three-level power conversion system 20 has been described as one example of the multilevel power conversion system 20. Concerning this point, the n-level power conversion system 20A is also one example of the multilevel power conversion system 20. Thus, also in the n-level power conversion system 20A according to the modification of one embodiment illustrated in FIG. 29, operational effects similar to the operational effects of the three-level power conversion system 20 described in FIG. 23 to FIG. 28 are provided.

Note that while in the modification of one embodiment illustrated in FIG. 29, a case has been described as an example where the injection carrier is a triangle wave, the injection carrier is not limited to this, and the injection carrier may be a wave other than the triangle wave if the signal has the same cycle as the cycle of the carrier waves CA1, CA2, . . . , CAn−1 and has a phase opposite to the phase of the carrier waves CA1, CA2, . . . CAn−1. Even if the injection carrier is a wave other than the triangle wave, for example, a sinusoidal wave, a rectangular wave, or the like, operational effects similar to the operational effects of the modification of one embodiment illustrated in FIG. 29 are provided.

### <Hardware Configuration Example>

FIG. 30 is a conceptual diagram illustrating a hardware configuration example of a processing circuit 90 of the controller 40 in one embodiment and the modification of the one embodiment indicated in FIG. 1 to FIG. 5 and FIG. 19 to FIG. 29. The above-described respective functions are implemented by the processing circuit 90. As one aspect, the processing circuit 90 includes at least one processor 91 and at least one memory 92. As another aspect, the processing circuit 90 includes at least one piece of dedicated hardware 93.

In a case where the processing circuit 90 includes the processor 91 and the memory 92, the respective functions are implemented by software, firmware or a combination of software and firmware. At least one of software or firmware is described as a program. At least one of software or firmware is stored in the memory 92. The processor 91 implements the respective functions by reading out and executing the program stored in the memory 92.

In a case where the processing circuit 90 includes the dedicated hardware 93, the processing circuit 90 is, for example, a single circuit, a composite circuit, a programmed processor or a combination thereof. The respective functions are implemented by the processing circuit 90.

Part or all of the respective functions of the controller 40 may be constituted of hardware or may be constituted as a program to be executed by the processor. In other words, the controller 40 can be implemented by a computer and a program, and the program can be stored in a storage medium or can be provided through a network.

### Supplementary Note of Embodiment

According to the embodiment indicated in FIG. 1 to FIG. 5 and FIG. 19 to FIG. 29, while the multilevel power converter 30 employing the NPP scheme has been described as one aspect of the present disclosure, the present disclosure is not limited to this. The present disclosure may be applied to the multilevel power converter 30 employing other schemes, such as, for example, the multilevel power converter 30 employing an NPC scheme and the multilevel power converter 30 employing an MMC scheme.

Further, according to the embodiment indicated in FIG. 1 to FIG. 5 and FIG. 19 to FIG. 29, while the power conversion systems 20 and 20A and the controller 40 (control unit 50) of the power conversion systems 20 and 20A have been described as one aspect of the present disclosure, the present disclosure is not limited to this. The present disclosure can be implemented as a control method in which processing steps at the respective units of the controller 40 (control unit 50) are performed.

Further, the present disclosure can be implemented as a control program that causes a computer to execute the processing steps at the respective units of the controller 40 (control unit 50).

Further, the present disclosure can be implemented as a storage medium (non-transitory computer-readable storage medium) in which the control program is stored. The control program can be stored in, for example, a removable medium such as a compact disc (CD), a digital versatile disc (DVD), and a universal serial bus (USB) memory and distributed. Note that the control program may be uploaded on a network via a network interface (not illustrated), or the like, of the controller 40 or may be downloaded from the network and stored in the storage unit 43, the memory 92, or the like.

Features and advantages of the embodiment will be clear from the above detailed description. This is intended that the scope of the claims covers the features and the advantages of the embodiment as described above within a range not deviating from the spirit and scope of right. Further, a person having ordinary knowledge in the technical field can easily conceive of every modification and change. Thus, the scope of the embodiment having inventiveness is not intended to be limited to that described above and can include appropriate modifications and equivalents included in the scope disclosed in the embodiment.

### REFERENCE SIGNS LIST

11 . . . Photovoltaics; 12 . . . DC cable; 13 . . . AC cable; 14 . . . Transformer; 15 . . . AC electric power system (electric power system, system); 20 . . . Multilevel power conversion system (three-level power conversion system, power conversion system); 20A . . . Multilevel power conversion system (n-level power conversion system, power conversion system); 21 . . . DC switch; 22 . . . AC reactor; 23 . . . AC capacitor; 24 . . . AC switch; 25 . . . DC voltage sensor; 26 . . . AC current sensor; 30 . . . Multilevel power converter (three-level power converter, power converter, inverter); 30A . . . Multilevel power converter (n-level power converter, power converter, inverter); 31 . . . DC input/output unit; 32, . . . AC input/output unit; 40 . . . Controller; 41 . . . Acquisition unit; 42 . . . Output unit; 43 . . . Storage unit; 45 . . . System bus; 50 . . . Control unit; 51 . . . Operation control unit; 52 . . . Voltage command generation unit; 53, 53A . . . Gate signal generation unit; 60 . . . Injection carrier generator; 61, 62, 63, 64 . . . Carrier generator; 90 . . . Processing circuit; 91 . . . Processor; 92 . . . Memory; 93 . . . Hardware; 120 . . . Multilevel power conversion system (three-level power conversion system, power conversion system); 130A to 130D . . . (Three-level power converter, n-level power converter, power converter, inverter); 153 . . . Gate signal generation unit; AC . . . AC terminal; C . . . DC neutral point; CA1 . . . Triangle wave carrier (upper carrier wave, carrier wave); CA2 . . . Triangle wave carrier (lower carrier wave, carrier wave); CA3, CA4 . . . Triangle wave carrier (carrier wave); CAin . . . Injection carrier; Cell #1 to Cell #4 . . . Chopper cell; Cn, Cp . . . DC capacitor; D . . . Modulated wave; D1 to D4 . . . Freewheeling diode (inverse parallel diode, diode); D5, D6 . . . Diode; Dca . . . Modulated wave; Du, Dv, Dw . . . Modulated wave; Duca, Dvca, Dwca . . . Modulated wave; fc . . . Carrier frequency; fo . . . Fundamental frequency (Fundamental frequency, modulated wave frequency); G . . . Gate signal; G1 to G4 . . . Gate signal; Gu1 to Gu4, Gv1 to Gv4, Gw1 to Gw4 . . . Gate signal; Iu, Iv, Iw . . . AC current value (AC current, current measurement value, current); I_ref, Iu_ref, Iv_ref, Iw_ref . . . Current command value; Kp . . . Proportional control gain; N . . . Negative terminal; NC . . . No connection terminal; P . . . Positive terminal; P_ref . . . Output power command value (power command value); Q1, Q4 . . . Semiconductor switching element (semiconductor element, element); Q2, Q3 . . . Semiconductor switching element (neutral point element, semiconductor element, element); T . . . Cycle; T1 to T4 . . . Interval; V ref, Vu_ref, Vv_ref, Vw_ref . . . Voltage command value; Vde . . . DC voltage value (DC voltage, voltage measurement value, voltage)

1. A controller for a multilevel power conversion system which includes a multilevel power converter including a plurality of semiconductor switching elements and a plurality of neutral point elements and in which a carrier level shift modulation scheme is used, the controller is comprising:
circuitry configured to execute:
processing of generating a modulated wave based on a voltage command value of each phase;
processing of generating carrier waves that are triangle wave signals having a predetermined carrier cycle;
processing of generating an injection carrier which changes in a predetermined amplitude range and which is a signal having the same carrier cycle as the carrier cycle of the carrier waves and having a phase opposite to a phase of the carrier waves;
processing of generating a modulated wave subjected to carrier injection control of superimposing the modulated wave and the injection carrier, and
processing of generating a gate signal that controls operation of the plurality of semiconductor switching elements and the plurality of neutral point elements in the multilevel power converter based on a result of comparing the modulated wave subjected to the carrier injection control with a plurality of the carrier waves.

2. The controller according to claim 1, wherein
the predetermined amplitude range of the injection carrier is a range smaller than an amplitude of the carrier waves.

3. The controller according to claim 2, wherein
the predetermined amplitude range of the injection carrier is a range of 20% to 30% of the amplitude of the carrier waves.

4. The controller according to claim 1, wherein
the predetermined amplitude range of the injection carrier is made to dynamically fluctuate in accordance with a situation of a DC voltage and a modulation factor.

5. The controller according to claim 4, wherein
the predetermined amplitude range of the injection carrier is made smaller in a case where the DC voltage is lower and is made greater in a case where the DC voltage is higher.

6. The controller according to claim 1, wherein
the injection carrier is a triangle wave signal which changes in a predetermined amplitude range, which has the same carrier cycle as the carrier cycle of the carrier waves and which has a phase opposite to a phase of the carrier waves.

7. A multilevel power conversion system in which a carrier level shift modulation scheme is used, the multilevel power conversion system comprising:
a multilevel power converter which includes:
a plurality of DC capacitors connected in series via a DC neutral point between a positive terminal connected to a DC power supply or a DC load and a negative terminal;
a plurality of semiconductor switching elements connected between the positive terminal and the negative terminal, and an AC terminal connected to an AC power supply or an AC load; and
a plurality of neutral point elements connected between the DC neutral point and the AC terminal; and
circuitry is configured to execute:
processing of generating a modulated wave based on a voltage command value of each phase;
processing of generating carrier waves that are triangle wave signals having a predetermined carrier cycle;
processing of generating an injection carrier which changes in a predetermined amplitude range and which is a signal having a phase opposite to a phase of the carrier waves and having the same carrier cycle as the carrier cycle of the carrier waves;
processing of generating a modulated wave subjected to carrier injection control of superimposing the modulated wave and the injection carrier; and
processing of generating a gate signal that controls operation of the plurality of semiconductor switching elements and the plurality of neutral point elements in the multilevel power converter based on a result of comparing the modulated wave subjected to the carrier injection control with a plurality of the carrier waves.
